(19) United States
(12) Patent Application Publication
(10) Pub. No.: US 2006/0225203 A1
(43) Pub. Date: Oct. 12, 2006

(54) Stretcher, stretcher system and method for using the system

(75) Inventors: Takashi Hosoya, Hyogo (JP); Shotaro Kimura, Hyogo (JP); Keiichiro Kara, Hyogo (JP); Hiroaki Shirai, Hyogo (JP)

Correspondence Address: NIXON PEABODY, LLP, 401 9TH STREET, NW, SUITE 900, WASHINGTON, DC, 20004-2128, US

(73) Assignees: ShinMaywa Industries, Ltd, Hyogo (JP); SML, Ltd., Hyogo (JP)

(21) Appl. No.: 10/550,397

(22) PCT Filed: Mar. 26, 2004
(86) PCT No.: PCT/JP04/04384

§ 371 Date: Sep. 22, 2005

(30) Foreign Application Priority Data
Mar. 31, 2003 (JP) 2003-093388
Jul. 4, 2003 (JP) 2003-270979
Jul. 4, 2003 (JP) 2003-270931
Jul. 4, 2003 (JP) 2003-270975

(51) Int. Cl. A61G 7/10

(52) U.S. Cl. 5/86.1

(57) ABSTRACT

A stretcher 1 comprises a bed 21 on which a sick or injured person will be laid, legs 22 foldably provided on the bed 21, casters 23 provided at the legs 22, respectively, a tank 10 for storing high-pressure gas, pneumatic cylinders 8 and 9, and intake switches 11 and 13. When the intake switches 11 and 13 are turned ON, high-pressure gas is introduced from the tank 10 into the pneumatic cylinders 8 and 9 so that piston rods 28 are retracted. Thus, the legs 22 are given forces toward deployment so that the bed 21 is given an ascending force.

### TECHNICAL FIELD

This invention relates to a stretcher, a stretcher system and a method for using a stretcher.

### BACKGROUND ART

When ambulance officers carry a sick or injured person into an ambulance vehicle, a stretcher with foldable legs is conventionally used. Stretchers of such kind are each made up of a bed on which a sick or injured person will be laid and foldable legs, and typically used by two ambulance officers as follows.

After the ambulance officers transfer the stretcher to a site at which a sick or injured person exists, they fold up the legs of the stretcher, lower the bed to the ground and then lay the sick or injured person on the bed. Thereafter, both the ambulance officers lift up the bed at a time with one holding the head side of the bed and the other holding the feet side thereof. With ascent of the bed, the legs automatically deploy by self-weight. As a result, the stretcher stands up. When the bed is raised to a predetermined level, the legs are locked in a fully deployed position to support the bed. Then, the ambulance officers roll the stretcher on the ground while pushing or pulling it and then carry it into the ambulance vehicle.

Since the total weight of the bed and a sick or injured person is substantially great, a large force is required to lift up the bed. The bed lifting work is normally done by two ambulance officers, but the physical burden for each officer to do that work is considerably large. For example, when the total weight of the bed and the sick or injured person is 120 kg, the physical burden per officer is approximately 60 kg. Therefore, it is difficult for an ambulance officer with less muscle to smoothly do the lifting work.

Furthermore, in the initial stage of the lifting work, i.e., before the bed is lifted up to a certain level (for example, the level of the ambulance officer's waist), the ambulance officers must stoop to lift it up. Therefore, they are likely to experience excessive physical burdens on their body parts (especially waists). Hence, they often strained their body parts, particularly in the initial stage of the lifting work. In addition, it is difficult that people exert large strength in stooping positions. Therefore, it is difficult for ambulance officers to exert their full strength in the initial stage of the lifting work.

In order to reduce the physical burden of the lifting work, a leg standing mechanism for a stretcher is proposed in which a lockable gas damper is provided to use the repulsive force of the damper to assist the deployment of the legs (see Japanese Registered Utility-Model Publication No. 3058160).

For the stretcher with a leg standing mechanism, however, ambulance officers must apply an extra force to the bed against the damper's force when folding up the legs. Therefore, its convenience is poor. Further, since the repulsive force of the damper is not so much larger than the weight of a sick or injured person, it is hard to say that the physical burden of the lifting work is reduced enough. If, conversely, the repulsive force of the damper is increased, the force required to fold up the legs is also increased accordingly. Therefore, in consideration of the folding of the legs, it is impossible to increase the repulsive damper force so much. In conclusion, it is difficult for any prior-art stretcher to extensively reduce the physical burden of the lifting work.

Furthermore, in carrying a stretcher in an ambulance vehicle, the stretcher is normally put on a support platform (the floor of the ambulance vehicle or a platform mounted on the ambulance vehicle, such as a vibration isolation platform) by a single ambulance officer. Specifically, the ambulance officer releases the legs from their locked state and pushes the stretcher into the vehicle from rear so that the stretcher can ride on the support platform.

In order to put the stretcher onto the support platform, an ambulance officer must push the stretcher onto the support platform while keeping the bed of the stretcher raised (in other words, keeping the legs deployed). Therefore, the ambulance officer is required to exert a force to keep the raised position of the bed and a force to push the stretcher onto the support platform. Since, however, the total weight of the stretcher on which the sick or injured person is laid is considerably large, a large physical burden is imposed on the ambulance officer when the stretcher is carried into the ambulance vehicle.

To cope with this, Japanese Unexamined Patent Publication No. 2002-153512 proposes a stretcher transfer system which includes a hook for guiding a stretcher onto a support platform mounted on an ambulance vehicle and a chain for winding up the hook in order to automatically draw the stretcher onto the support platform.

Since the above transfer system automatically draws the stretcher, this can reduce the force for an ambulance officer to push the bed onto the support platform. However, the transfer system cannot reduce the force to keep the bed raised. Therefore, for any ambulance officer with less muscle who has difficulty in supporting the weight of the stretcher, it is difficult to carry out the carrying-in of the stretcher.

Furthermore, in carrying the stretcher into the ambulance vehicle, the locking mechanism for the legs must be released. At the moment of release of the locking mechanism, the whole weight of the stretcher is applied to the ambulance officer. Therefore, even an ambulance officer with sufficient muscle was likely to strain his body part (especially the back) due to shock at the moment of release of the locking mechanism.

### DISCLOSURE OF THE INVENTION

With the foregoing in mind, the present invention has been made. An object of the invention is to extensively reduce the physical burden of lifting of the stretcher and to make it possible even for a person with less muscle to smoothly lift up the stretcher. Another object of the invention is to reduce the force required to keep the raised position of the bed in putting the stretcher onto the support platform thereby reducing the physical burden on the lifting worker. Still another object of the invention is to make it possible even for a person with less muscle to put the stretcher onto the support platform.

A stretcher of the present invention is a stretcher including a bed on which a sick or injured person will be laid, legs foldably provided on the bed and casters provided at the legs, respectively.

The above stretcher further comprises an ascent assist device having: a lifting mechanism for giving the bed an ascending force; and a switch for turning the lifting mechanism ON/OFF.

Another stretcher of the present invention is a stretcher including a bed on which a sick or injured person will be laid, legs foldably provided on the bed and casters provided at the legs, respectively, and the stretcher further comprises an ascent assist device having: an actuator into which high-pressure gas is introduced to give the bed an ascending force; and a switch for turning the actuator ON/OFF.

With the above stretcher, when the switch is turned ON in lifting up the bed after a sick or injured person is laid on the bed, the actuator drives. As a result, an ascending force is exerted on the bed by high-pressure gas introduced in the actuator. Therefore, in the bed lifting work, ambulance officers can utilize a large force resulting from high-pressure gas, thereby extensively reducing the physical burdens on the ambulance officers. Further, even an ambulance officer with less muscle can smoothly do the bed lifting work. As a result, the ambulance officers can be prevented from straining their body parts.

Still another stretcher of the present invention is a stretcher including a bed on which a sick or injured person will be laid, legs foldably provided on the bed and configured to raise the bed by deploying from the bed, and casters provided at the legs, respectively, and the stretcher further comprises an ascent assist device having: an actuator into which high-pressure gas is introduced to give the legs forces toward deployment; and a switch for turning the actuator ON/OFF.

Also with the above stretcher, when the switch is turned ON in lifting up the bed after a sick or injured person is laid on the bed, the actuator drives. As a result, forces toward deploying the legs are exerted on the legs by high-pressure gas introduced in the actuator, and an ascending force is exerted on the bed with the deployment of the legs. Therefore, in the bed lifting work, ambulance officers can utilize a large force resulting from high-pressure gas, thereby extensively reducing the physical burdens on the ambulance officers. Further, even an ambulance officer with less muscle can smoothly do the bed lifting work.

The stretcher preferably further comprises a tank for storing high-pressure gas and a gas pipe line for connecting the tank and the actuator.

Note that the pipe used in the gas pipe line herein referred to is not limited to a rigid pipe but may be a flexible pipe such as hose or tube.

Since the above stretcher is equipped with a tank for storing high-pressure gas, there is no need to bring a gas source (such as a gas container) for supplying high-pressure gas into the actuator to the site of the bed lifting work, in addition to the stretcher. Therefore, the convenience of the stretcher can be enhanced.

The actuator may be a pneumatic cylinder and the switch may be a switch for opening and closing the flow path of the gas pipe line.

Thus, the actuator and the switch can have relatively simple structures. The pneumatic cylinder is not limited to one using air as working fluid but may be one using another gas, such as oxygen or nitrogen, as working fluid.

It is preferable that the pneumatic cylinder has a cylinder body and a piston which divides the inner space of the cylinder body into a pressure chamber and a vented chamber and the stretcher further comprises a speed controller for controlling the speed of gas exhausted from the vented chamber.

When high-pressure gas is introduced into the pressure chamber of the pneumatic cylinder, the speed of gas exhausted from the vented chamber is controlled to control the moving speed of the piston. Thus, the ascending speed of the bed can be controlled depending on the lifting work of ambulance officers, thereby providing a smoother lifting work. In addition, an abrupt ascent of the bed can be prevented, which reduces the physical burden on the sick or injured person.

The gas pipe line may be provided with a speed controller for controlling the speed of high-pressure gas flowing from the tank into the pneumatic cylinder.

Thus, the ascending speed of the bed can be controlled depending on the lifting work of ambulance officers, thereby providing a smoother lifting work. In addition, an abrupt ascent of the bed can be prevented, which reduces the physical burden on the sick or injured person.

By the way, a normal ambulance vehicle is loaded with a gas source filled with high-pressure gas, such as a gas container for giving sick or injured persons oxygen.

Therefore, the stretcher is preferably formed with a gas inlet through which high-pressure gas is introduced into the tank from a gas source placed in an ambulance vehicle.

Preferably, before a sick or injured person is carried on the stretcher, the gas inlet is connected to the gas source in an ambulance vehicle and the tank is charged with high-pressure gas from the gas source. It is a matter of course that means for flowing gas therethrough, such as a pipe or a tube, may be used for the connection between the gas inlet and the gas source. In other words, the tank may be connected directly or indirectly to the gas source.

Therefore, a gas container or an air tank placed on the ambulance vehicle can be used as a gas source for supplying high-pressure gas into the tank for the stretcher. Hence, there is no need to always carry on the ambulance vehicle a dedicated gas source for supplying gas into the tank. Further, the work of filling the tank with gas can be done in advance in the ambulance vehicle. Therefore, ambulance work can be smoothly done. In addition, the convenience of the stretcher can be enhanced.

Still another stretcher of the present invention is a stretcher including a bed on which a sick or injured person will be laid, legs foldably provided on the bed and casters provided at the legs, respectively, and the stretcher further comprises an ascent assist device having: a lifting mechanism for giving the bed an ascending force; a switch for turning the lifting mechanism ON/OFF; and a speed control means for controlling the speed of the bed raised by the lifting mechanism.

With the above stretcher, when the switch is turned ON in lifting up the bed after a sick or injured person is laid on the bed, the lifting mechanism operates. As a result, an ascending force is exerted on the bed. Therefore, in the bed lifting work, the physical burdens on the ambulance officers can be reduced and even an ambulance officer with less muscle can smoothly do the lifting work. Further, since the stretcher comprises the speed control means for controlling the ascending speed of the bed, the ascending speed of the bed can be controlled depending on the lifting work of the ambulance officers, thereby providing a smoother lifting work. In addition, since an abrupt ascent of the bed can be prevented, this lessens the shock of the sick or injured person laid on the bed and thereby reduces his physical burden.

Each of the above stretchers preferably comprises a speed control means for controlling the descending speed of the bed when the raised bed is lowered.

Thus, the descending speed of the bed can be controlled, which allows the bed to be lowered smoothly. Therefore, the workload for the ambulance officers and the stress on the sick or injured person can be reduced. Further, since an abrupt descent of the bed can be prevented, the shock on the stretcher can be reduced. Therefore, the life of the stretcher can be extended.

Each of the above stretchers preferably comprises a deactivation means for deactivating the ascent assist device.

Using the deactivation means, the ascent assist device can be freely deactivated at any time. For example, in the event of failure of the ascent assist device, the bed can be raised by manual lifting-up work alone as the result of deactivation of the ascent assist device. Also, the bed can be lowered by manual pulling-down work alone. Therefore, it can be avoided that the ascent and descent of the bed are prevented due to failure of the ascent assist device, which enhances the reliability of the stretcher.

Still another stretcher of the present invention is a stretcher including a bed on which a sick or injured person will be laid, legs foldably provided on the bed to deploy with ascent of the bed and fold with descent of the bed, and casters provided at the legs, respectively, and the stretcher further comprises an initial ascent assist device for giving the bed an ascending force in an initial stage of a lifting work during which the bed is raised from the lowest level to a predetermined halfway level between the lowest and highest levels of the bed.

With the above stretcher, the initial ascent assist device gives the bed a large ascending force in the initial stage of a lifting work in which the ambulance officers are less likely to exhibit their potentials, which considerably reduces the physical burdens of the ambulance officers. Therefore, the ambulance officers can easily lift up the bed. In addition, the possibility can be reduced that the ambulance officers may strain their bodies. For this stretcher, after the bed is raised up to the halfway level, the assist function of the initial ascent assist device is eliminated. Since, even then, the ambulance officers can take their postures with which they can easily exhibit their strengths, they can smoothly implement the subsequent lifting work.

The initial ascent assist device may comprise: an actuator into which high-pressure gas is introduced to give the bed an ascending force; and a switch for turning the actuator ON/OFF.

The actuator may be a pneumatic cylinder.

Thus, an initial ascent assist device exhibiting a quite large force can be obtained.

The initial ascent assist device may comprise: a hydraulic actuator for giving the bed an ascending force; and a switch for turning the actuator ON/OFF.

The initial ascent assist device may comprise: a motor-driven actuator for giving the bed an ascending force; and a switch for turning the actuator ON/OFF.

The initial ascent assist device may comprise: a treadle lever pivotally mounted on the bed to angularly move through the depression by foot; and a link mechanism for converting a force of angular movement of the treadle lever to a force to raise the bed.

When the ambulance officer depresses the treadle lever, he can raise the bed up to the halfway level without stooping to lift up the bed. Therefore, the bed can be easily raised in the initial stage of the lifting work.

The above stretcher preferably further comprises a main ascent assist device for giving the bed an ascending force in a later stage of the lifting work during which the bed is raised from the halfway level to the highest level or over-all the stages of the lifting work during which the bed is raised from the lowest level to the highest level.

With this structure, the physical burden of the bed lifting work can be reduced not only in the initial stage of the lifting work but also in the later stage thereof or over all the stages thereof. If the main ascent assist device is activated over all the stages of the lifting work, the ascending force from the initial ascent assist device can be reduced to a small extent. This allows size reduction or weight reduction of the initial ascent assist device.

The main ascent assist device may be a device for giving the bed an ascending force by giving the legs forces toward deployment.

In the stretcher for assisting the ascent of the bed by giving the legs forces toward deployment, the load required for the deployment of the legs is highest in the initial stage of the deployment and gradually decreases with the progress of the deployment. Therefore, the need to assist the ascent of the bed in the initial stage is higher than in other types of stretchers. If the stretcher is equipped with the initial ascent assist device, the deployment of the legs in the initial stage can be implemented easily.

The main ascent assist device may comprise: a main actuator into which high-pressure gas is introduced to give the bed an ascending force; and a switch for turning the main actuator ON/OFF.

Thus, the ascent of the bed can be assisted using a large force resulting from high-pressure gas.

Still another stretcher of the present invention is a stretcher which includes a bed on which a sick or injured person will be laid, legs foldably provided on the bed to deploy with ascent of the bed and fold with descent of the bed, and casters provided at the legs, respectively, and is configured to be laid on a support platform with the legs folded up by pushing the legs against the support platform as the legs deploy, and the stretcher further comprises: a deployment force application mechanism for giving the legs forces toward deployment; and a deactivation mechanism for deactivating the deployment force application mechanism when the length of part of the stretcher laid on the support platform exceeds a predetermined length. Examples of the support platform herein referred to include platforms installed on the floors of ambulance vehicles, such as a vibration isolation platform, floors (rear decks) of ambulance cars, and platforms installed at sites other than the ambulance vehicles, such as hospitals.

With the above stretcher, when it is laid on the support platform, the deployment force application mechanism gives the legs forces toward deployment so that the bed is given an ascending force. Therefore, the force required for ambulance officers to keep the raised position of the bed is reduced, which reduces the physical burdens of the ambulance officers. Further, since the deployment force application mechanism gives the bed an ascending force even if the locking mechanism for the legs are released, the ambulance officers are less likely to experience a shock. Therefore, the ambulance officers are less likely to strain their bodies.

If the legs are kept deployed, the stretcher cannot be laid on the support platform. With the above stretcher, however, the deactivation mechanism deactivates the deployment force application mechanism when the length of part of the stretcher laid on the support platform exceeds the predetermined length. Thus, the legs can be easily folded up. As a result, the stretcher can be easily laid on the support platform. Therefore, according to this aspect of the present invention, the physical burdens of ambulance officers can be reduced.

The deployment force application mechanism may comprise a pneumatic cylinder, and the deactivation mechanism may comprise a gas release mechanism for releasing high-pressure gas in the pneumatic cylinder.

With this structure, the physical burden of the ambulance officers carry-in work can be reduced using the pressure of high-pressure gas.

Still another stretcher of the present invention is a stretcher which includes a bed on which a sick or injured person will be laid, front and rear legs foldably provided at the front and rear sides of the bed, and casters provided at the front and rear legs, respectively, and is configured to be laid on a support platform from the front side of the bed with the front and rear legs folded up by pushing the legs against the support platform as the front and rear legs deploy, and the stretcher further comprises: a deployment force application mechanism for giving at least the rear legs forces toward deployment; and a deactivation mechanism for releasing the forces toward deployment given to the rear legs from the deployment force application mechanism when the length of part of the stretcher laid on the support platform exceeds a predetermined length.

Also with the above stretcher, the physical burdens of ambulance officers can be reduced for the reasons mentioned already. Further, the ambulance officers are less likely to strain their bodies.

The bed may include a rail extending in a longitudinal direction of the bed, at least the front legs may be provided with a slider for sliding on the rail according to the deployment and folding of said at least front legs, and the deactivation mechanism may comprise a position sensor for detecting whether the slider passes through a predetermined position on the rail and may be configured to deactivate the deployment force application mechanism when the slider passes through the predetermined position.

With the above structure, when the slider passes through the predetermined position, it is detected that the length of part of the stretcher laid on the support platform has reached a predetermined length. As a result, the deployment force application mechanism is deactivated. Therefore, the deployment force application mechanism can be automatically deactivated with a simple structure.

The above stretcher may further comprise a locking mechanism for locking the front and rear legs in deploying positions such that the locking can be released in laying the stretcher onto the support platform, wherein the deployment force application mechanism comprises a pneumatic cylinder and the deactivation mechanism comprises a gas release mechanism for releasing high-pressure gas in the pneumatic cylinder when the slider passes through the predetermined position.

With this structure, the physical burden of the ambulance officers carry-in work can be reduced using the pressure of high-pressure gas.

A stretcher system of the present invention comprises: any one of the above-mentioned stretchers; a support platform on which the stretcher is laid, wherein the support platform is provided with a conveyer for conveying the stretcher onto the support platform.

With the above stretcher system, the stretcher is automatically conveyed onto the support platform in laying the stretcher on the support platform. Therefore, not only the force to keep the raised position of the bed can be reduced but also the force to push in the stretcher to the top of the support platform can be reduced. As a result, the physical burdens of ambulance officers can be further reduced.

### BRIEF DESCRIPTION OF THE DRAWINGS

FIG. 1 is a side view of a stretcher according to Embodiment 1 with the legs deployed.

FIG. 2 is a side view of the same stretcher with the legs folded up.

FIG. 3 is a plan view, partly broken away, of the same stretcher with the legs folded up.

FIG. 4 is a piping diagram of the same stretcher.

FIG. 5 is a schematic diagram showing how the stretcher is connected to an oxygen container in an ambulance vehicle.

FIG. 6 is a gas piping diagram according to a variant.

FIG. 7 is a plan view, partly broken away, of a stretcher according to Embodiment 2.

FIG. 8 is a piping diagram of the same stretcher.

FIG. 9 is a side view of a stretcher according to a modification.

FIG. 10 is a side view of a stretcher according to another modification.

FIG. 11 is a side view of a stretcher according to Embodiment 3.

FIG. 12 is a side view of the same stretcher.

FIG. 13 is a side view of a stretcher according to Embodiment 4.

FIG. 14 is a side view of a stretcher according to Embodiment 5.

FIG. 15 is a side view of a stretcher according to Embodiment 6.

FIG. 16 is a side view of a stretcher according to Embodiment 7.

FIG. 17 is a side view of a stretcher according to Embodiment 8.

FIG. 18 is a side view of the same stretcher.

FIG. 19 is a side view of a stretcher according to Embodiment 9.

FIG. 20 is a piping diagram of the same stretcher.

FIG. 21 is a graph showing the relation between bed level and required physical burden.

FIG. 22 is a piping diagram of a stretcher according to Embodiment 10.

FIG. 23 is a side view of the same stretcher when carried in.

FIG. 24 is a diagram for illustrating the carrying-in of the same stretcher.

FIG. 25 is a diagram for illustrating the carrying-in of the same stretcher.

FIG. 26 is a diagram for illustrating the carrying-in of the same stretcher.

FIG. 27 is a diagram for illustrating the carrying-in of the same stretcher.

FIG. 28 is a diagram for illustrating the carrying-in of the same stretcher.

FIG. 29 is a side view of a hook carriage.

FIG. 30 is a side view of the hook carriage.

FIG. 31 is a side view of the hook carriage.

### BEST MODE FOR CARRYING OUT THE INVENTION

Embodiments of the present invention will be described below with reference to the drawings.

### Embodiment 1

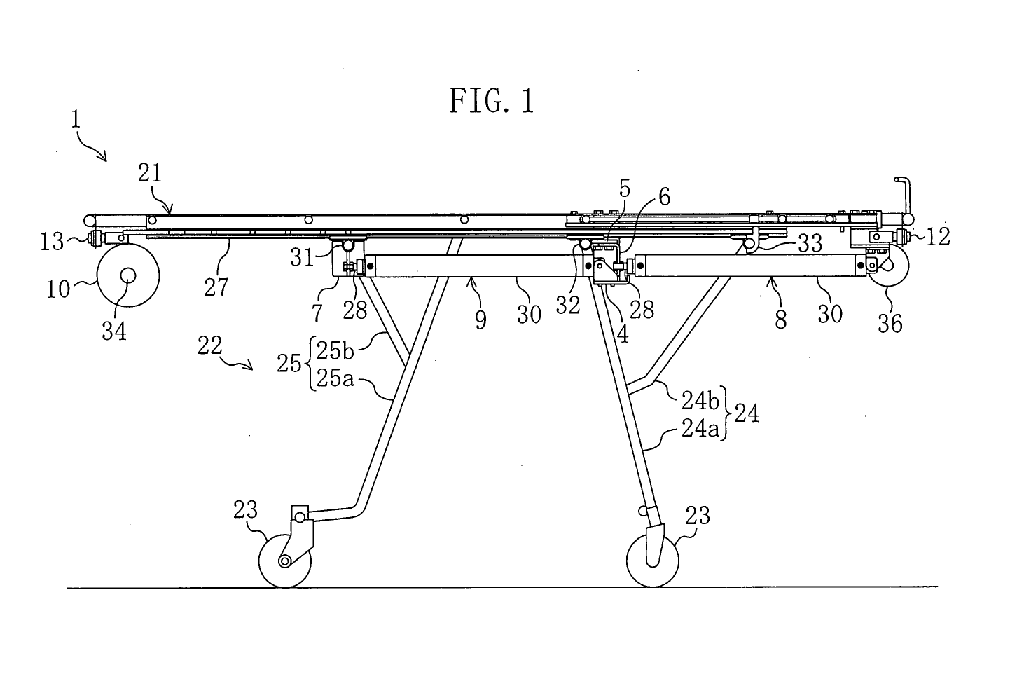

As shown in FIG. 1, a stretcher 1 of Embodiment 1 comprises a bed 21 on which a sick or injured person will be laid, and legs 22 foldably provided on the bed 21. Hereinafter, the side of the stretcher at which the head of a sick or injured person laid thereon comes (right side in FIGS. 1 to 3) is referred to as the head side while the other side at which the feet of the sick or injured person comes (left side in FIGS. 1 to 3) is referred to as the feet side.

The bed 21 is made up of a so-called framed structure and is formed by assembling a plurality of pipe members. The bed 21 supports, at some points on the structure of the pipe members, a litter (not shown) for riding a sick or injured person thereon. In this embodiment, the bed 21 is formed separately from the litter. It is a matter of course that the bed 21 may be equipped with a litter. In other words, the bed 21 may be formed integrally with the litter.

The legs 22 consist of two front legs 24 and two rear legs 25. The front legs 24 are legs provided at the head side of the stretcher and are each composed of a main leg 24a and a sub leg 24b pivotally connected halfway to the main leg 24a. Each main leg 24a is provided at its distal end with a caster 23. The rear legs 25 are legs provided at the feet side of the stretcher and are each composed of a main leg 25a and a sub leg 25b pivotally connected halfway to the main leg 25a. Each main leg 25a is also provided at its distal end with a caster 23.

The root ends of the main legs 25a are pivotally supported to the bed 21. On the other hand, the root ends of the sub legs 25b of the rear legs 25, the root ends of the main legs 24a of the front legs 24 and the root ends of the sub legs 24b of the front legs 24 are pivotally supported to sliders 31, 32 and 33, respectively. The bed 21 is formed with a longitudinally extending rail 27. The sliders 31, 32 and 33 are slidably mounted to the rail 27 (wherein the slider 33 is locked to a fixed point of the bed while the bed 21 is being raised and lowered).

According to the above structure, when the bed 21 is raised, the sliders 31 and 32 move to the head side so that the legs 22 deploy. On the other hand, when the bed 21 is lowered, the sliders 31 and 32 move to the feet side so that the legs 22 are folded. In other words, the bed 21 ascends with deployment of the legs 22, while the bed 21 descends with the folding of the legs 22.

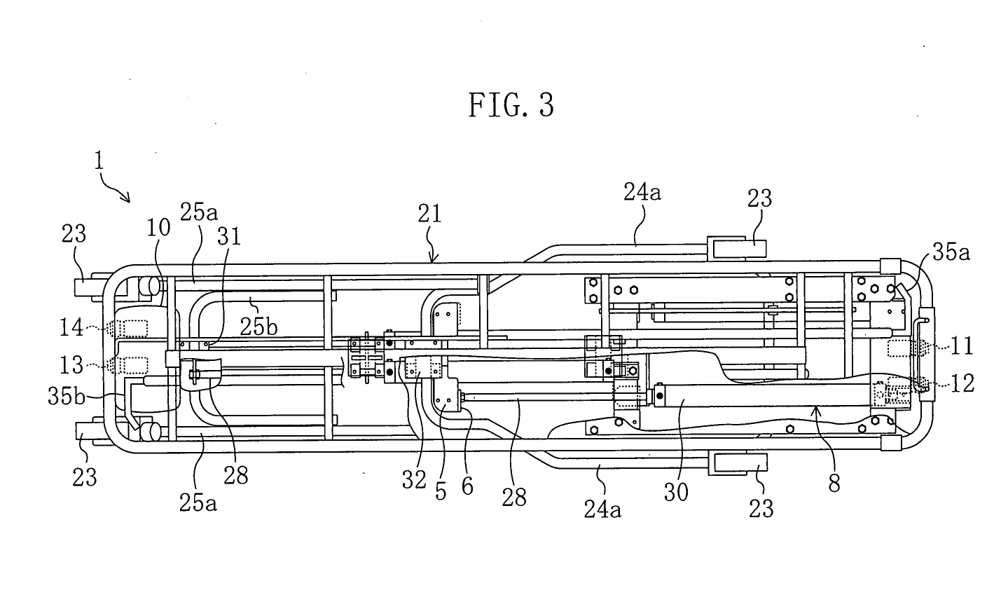

The stretcher 1 is provided with a locking mechanism (not shown) for the legs 22. When the bed 21 ascends to a predetermined level so that the deployment of the legs 22 is completed, the legs 22 are automatically locked. The head and feet sides of the bed 21 are provided with unlocking levers 35a and 35b (see FIG. 3), respectively, for releasing the locking mechanism. When the unlocking levers 35a, 35b are pulled, the locking mechanism is released to allow the folding of the legs 22 (in other words, the descent of the bed 21).

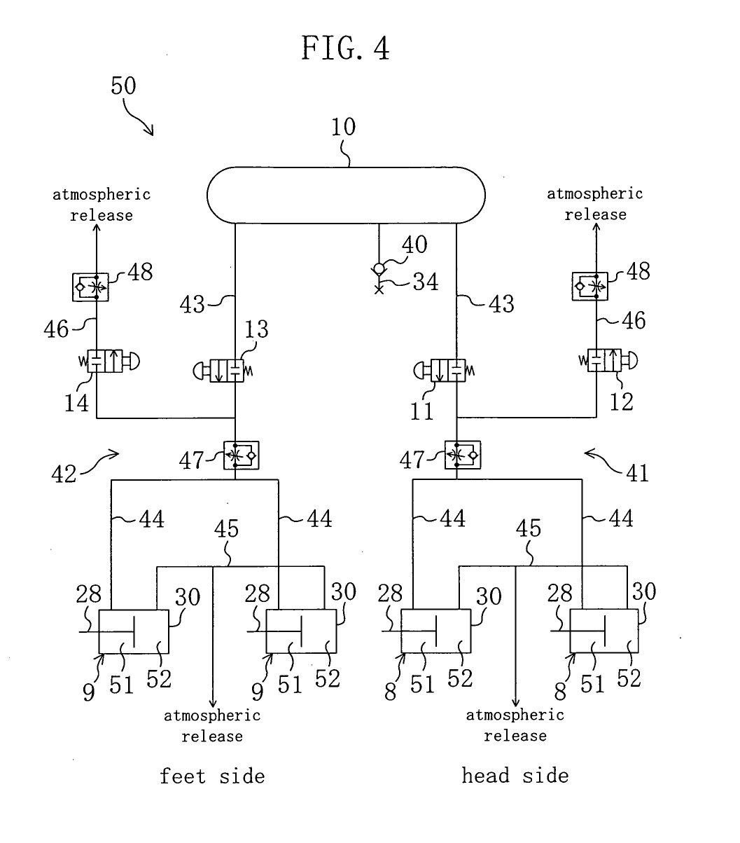

On the bottom of the bed 21, a pair of head-side right and left pneumatic cylinders 8 and a pair of feet-side right and left pneumatic cylinders 9 are mounted. Each of these pneumatic cylinders 8 and 9 consists of a cylindrical body 30 and a piston rod 28 inserted in the body 30. The inner space of the body 30 is divided into a pressure chamber 51 and a vented chamber 52 by the piston rod 28 (see FIG. 4). Each pneumatic cylinder 8, 9 in the present embodiment is configured so that high-pressure gas is introduced into the pressure chamber 51 of the cylinder body 30 and the pressure of the high-pressure gas is used to allow the piston rod 28 to produce a retraction force.

Each pneumatic cylinder 8, 9 is placed substantially in parallel with the longitudinal direction of the bed 21. A cylinder fitting 4 is provided to the distal end of the body 30 of the pneumatic cylinder 8. The piston rods 28 of the head-side pneumatic cylinders 8 are secured to the slider 32 through drawing blocks 5 and drawing plates 6, respectively. Thus, the slider 32 slides backward and forward (to the left and right in FIGS. 1 to 3) according to the extension and retraction, respectively, of the piston rod 28. On the other hand, the piston rods 28 of the feet-side pneumatic cylinders 9 are secured to the slider 31 through drawing plates 7, respectively. Thus, the slider 31 slides backward and forward according to the extension and retraction, respectively, of the piston rod 28.

A tank 10 for storing high-pressure gas is attached at the feet side of the bed 21. The tank 10 is formed with a gas inlet 34 through which high-pressure gas is externally introduced. The gas inlet 34 is provided with an opening/closing means 40 such as a check valve or a shut-off valve (see FIG. 4 but not given in FIGS. 1 to 3), and is configured to be able to open and close with the help of the opening/closing means 40. The tank 10 is connected to the individual pneumatic cylinders 8 and 9 through corresponding gas pipe lines (not given in FIGS. 1 to 3). Thus, with this stretcher 1, high-pressure gas is supplied from the attached tank 10 to each of the pneumatic cylinders 8 and 9.

There is no limit on the shape, size and attached position of the tank 10. The tank 10 need only have a capacity enough to be able to operate the pneumatic cylinders 8 and 9 at least once. Alternatively, in order to allow for a reattempt to lift up the bed and concurrently achieve size reduction of the tank 10, the tank 10 may have a capacity enough to be able to operate the pneumatic cylinders 8 and 9 a few times. Further, there is also no limit on the piping arrangement of the gas pipe lines. The gas pipe line may be constituted by stainless pipes, aluminum pipes, iron pipes or pipes made of other kinds of metals or may be constituted by flexible pipes. The gas pipe line can be constituted by pressure-tight hoses or tubes.

FIG. 4 shows a piping diagram for high-pressure gas. The piping system 50 is composed of a head-side piping system 41 for controlling the head-side pneumatic cylinders 8 and a feet-side piping system 42 for controlling the feet-side pneumatic cylinders 9.

The head-side piping system 41 has an intake pipe 43 for leading high-pressure gas thereinto from the tank 10, two branch pipes 44 branched from the intake pipe 43 and then connected to the pressure chambers 51 of the pneumatic cylinders 8, a release pipe 45 for communicating the vented chambers 52 of the pneumatic cylinders 8 with the outside, and an exhaust pipe 46 for exhausting high-pressure gas in the pressure chambers 51 of the pneumatic cylinders 8 to the outside. The intake pipe 43 is equipped with, in the order away from the tank 10, an intake switch 11 formed of a mechanical valve and a speed controller (speed control valve) 47. One end of the exhaust pipe 46 is connected between the intake switch 11 and the speed controller 47 in the intake pipe 43, while the other end is open to the outside. The exhaust pipe 46 is equipped with an exhaust switch 12 formed of a mechanical valve and a speed controller 48.

The feet-side piping system 42 has the same structure as the head-side piping system 41. An intake pipe 43 of the feet-side piping system 42 is also equipped with an intake switch 13 and a speed controller 47. An exhaust pipe 46 of the feet-side piping system 42 is also equipped with an exhaust switch 14 and a speed controller 48.

The piping system 50 including the pneumatic cylinders 8 and 9, the intake switches 11 and 13 and the speed controllers 47 constitutes an ascent assist device for assisting the ascent of the bed 21. The speed controller 47 in the intake pipe 43 constitutes a speed control means for controlling the ascending speed of the bed 21, while the speed controller 47 in the exhaust pipe 46 constitutes a speed control means for controlling the descending speed of the bed 21.

As shown in FIG. 3, the intake switch 11 and the exhaust switch 12 in the head-side piping system 41 are placed at the front side (i.e., head side) of the bed 21. The intake switch 11 and the exhaust switch 12 are both push-button switches and are arranged in positions oriented frontward in consideration of ease of operation of an ambulance officer operating the stretcher 1 from the front. On the other hand, the intake switch 13 and the exhaust switch 14 in the feet-side piping system 42 are placed at the rear side (i.e., feet side) of the bed 21. The intake switch 13 and the exhaust switch 14 are also push-button switches and are arranged in positions oriented rearward in consideration of ease of operation of an ambulance officer operating the stretcher 1 from the rear.

Note that the intake switches 11 and 13 and the exhaust switches 12 and 14 are not limited to push-button switches but may be other types of switches. For example, rotary switches (such as dial switches) or lever-pulling switches may be used.

Next, the usage and behavior of the stretcher 1 will be described.

In using the stretcher 1, high-pressure gas can be supplied to the tank 10 on site but, in order to promptly do ambulance work, the tank 10 is preferably filled with high-pressure gas prior to the arrival of an ambulance vehicle at the site. The tank 10 may be filled with high-pressure gas before the stretcher 1 is loaded on an ambulance vehicle. Generally, many ambulance vehicles are loaded with high-pressure gas sources such as oxygen containers for oxygen inhalation or air tanks for storing compressed air. Therefore, in the course of travel of an ambulance vehicle to the site, the tank may be filled with high-pressure gas using a high-pressure gas source placed on the vehicle.

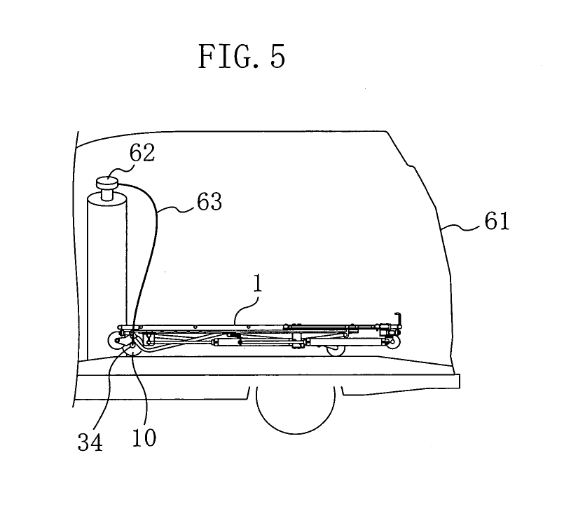

For example, as shown in FIG. 5, an oxygen container 62 placed on an ambulance vehicle 61 may be connected to the gas inlet 34 of the tank 10 of the stretcher 1 through a pressure-tight tube 63 or the like so that high-pressure gas can be supplied from the oxygen container 62 to the tank 10. It suffices if the pressure of high-pressure gas in the tank 10 is set, for example, at approximately 5 to 10 atmospheres. Therefore, in order to supply a sufficient amount of high-pressure gas to the tank 10, a normal gas container (with a pressure of about 20 to 30 atmospheres) will suffice. However, the required pressure for the tank 10 is not limited to the above-described numeric range of atmospheres.

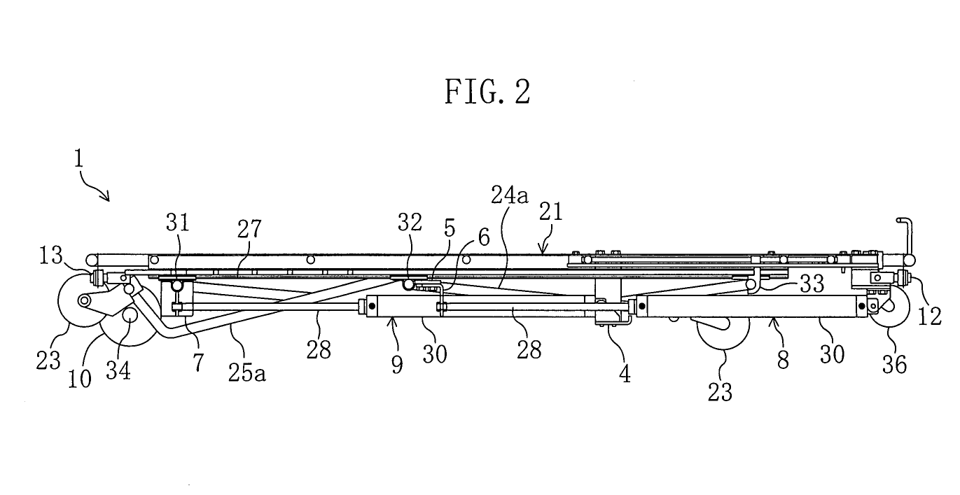

When an ambulance vehicle arrives at the site, an ambulance officer takes the stretcher 1 out of the ambulance vehicle. In doing so, the ambulance officer pulls the feet-side unlocking lever 35b and draws the stretcher 1 out of the ambulance vehicle while pushing the intake switch 13. As a result, in the feet-side piping system 42 of the gas piping system 50, high-pressure gas is introduced from the tank 10 through the intake switch 13 to the pressure chambers 51 of the pneumatic cylinders 9. Thus, the rear legs 25 are deployed. The front legs 24 automatically deploy by self-weight when the stretcher 1 is taken out. In this manner, the stretcher 1 changes from a position in which the legs 22 are folded (the position shown in FIG. 2) to a position in which the legs 22 are deployed (the position shown in FIG. 1), so that it can travel on the ground. In this state, the ambulance officer or officers roll the stretcher 1 while pushing or pulling it until they move the stretcher 1 to the vicinity of a sick or injured person.

When the stretcher 1 is moved to the vicinity of the sick or injured person, two ambulance officers carry out operations of lowering and raising the bed 21 while they are present to the front and rear, respectively, of the stretcher 1. In the lowering operation, concurrently with the release of the locking mechanism (not shown) for the legs 22 through the pulling of the unlocking levers 35a and 35b, the ambulance officer present to the front of the stretcher 1 pushes the head-side exhaust switch 12 (but does not need to push the exhaust switch 12 if the pneumatic cylinders 8 are not filled with high-pressure gas) and the other ambulance officer present to the rear thereof pushes the feet-side exhaust switch 14. As a result, the bed 21 is lowered. In other words, the legs 22 are folded up. Then, the sick or injured person is laid on the bed 21.

In the raising operation, concurrently with the pulling of the unlocking levers 35a and 35b, the ambulance officer present to the front of the stretcher 1 pushes the head-side intake switch 11 and the other ambulance officer present to the rear thereof pushes the feet-side intake switch 13. As a result, in the head-side piping system 41 of the gas piping system 50, high-pressure gas is introduced from the tank 10 through the intake switch 11 and the speed controller 47 to the pressure chambers 51 of the pneumatic cylinders 8. At the same time, in the feet-side piping system 42, high-pressure gas is introduced from the tank 10 through the intake switch 13 and the speed controller 47 to the pressure chambers 51 of the pneumatic cylinders 9.

Concurrently with or after the pushing of the intake switches 11 and 13, the ambulance officers lift up the bed 21. At the time, since high-pressure gas is introduced into the pressure chambers 51 of the pneumatic cylinders 8 and 9, retraction forces are applied to the piston rods 28. Therefore, the sliders 32 and 31 connected to the piston rods 28 receive forces toward the head side (right side in FIGS. 2 and 3) while the legs 22 receive forces toward deployment. As a result, the ambulance officers can lift up the bed 21 with small strengths.

When lifting the bed 21 up to a predetermined level, the ambulance officers release the unlocking levers 35a and 35b so that the locking mechanism acts to hold the legs 22 in a deployed position. Thereafter, the ambulance officers carry the stretcher 1 into the ambulance vehicle. In doing so, the ambulance officers push the stretcher 1 from its head side into the ambulance vehicle and then turns the exhaust switch 14 ON while pulling the feet-side unlocking lever 35b. As a result, the exhaust pipe 46 is open to the atmosphere to discharge high-pressure gas in the pressure chambers 51 of the pneumatic cylinders 9 through the exhaust switch 14 and the speed controller 48 to the outside. During the time, the legs 22 are folded. Therefore, if the stretcher 1 is pushed into the ambulance vehicle concurrently with the folding of the legs 22, it can be easily carried in the vehicle. The front legs 24 are folded as the result of backward sliding movement of the slider 33 even if high-pressure gas in the pneumatic cylinders 8 is not exhausted.

As described above, the stretcher 1 has a power assist function for assisting the ambulance officers work of lifting up the bed 21. According to the present embodiment, while the ambulance officers lift up the bed 21, the pneumatic cylinders 8 and 9 apply large forces toward deploying the legs 22 to the stretcher 1 so that a large upward force can be given to the bed 21. Therefore, the physical burdens of the ambulance officers can be extensively reduced. This makes it possible for even an ambulance officer with less muscle to smoothly lift up the bed 21. In addition, the ambulance officers can reduce their fatigue due to the lifting work and can be prevented from straining their bodies (for example, their backs).

Since the intake pipe 43 is provided with a speed controller 47 to control the speed of high-pressure gas flowing from the tank 10 into the pneumatic cylinders 8 and 9, this can prevent the legs 22 from abruptly deploying. Therefore, the bed 21 can be raised slowly so that a physical burden due to shock or vibrations is not imposed on the sick or injured person. In addition, the standing speed of the legs 22 can be controlled freely depending on the lifting work of the ambulance officers and the sick or injured person's weight, which provides a more efficient lifting work.

Since the exhaust pipe 46 is provided with a speed controller 48 to control the exhausting speed of high-pressure gas in the pneumatic cylinders 8 and 9, this can prevent high-pressure gas from being abruptly discharged. Therefore, the convenience of the stretcher 1 can be enhanced without unnecessary shock given to the sick or injured person and ambulance officers at the discharge of high-pressure gas. Further, abrupt descent of the bed 21 can be prevented, which reduces the workloads of the ambulance officers and the sick or injured person's stress. Furthermore, since less shock is applied to the stretcher 1, this extends the life of the stretcher 1.

Since pneumatic cylinders 8 and 9 are used as actuators for assisting the work of lifting up the bed 21, the actuators can be constructed relatively simply. In addition, since the structure and behavior of the actuators are simple, this provides highly reliable actuators. Further, the actuators can be reduced in weight.

Since the stretcher 1 is equipped with the tank 10 for storing high-pressure gas, this eliminates the need for an additional gas source for supplying high-pressure gas into the pneumatic cylinders 8 and 9, such as a gas container, which allows free operation of the pneumatic cylinders 8 and 9 at any time at the site where the stretcher 1 has been carried.

In this embodiment, the tank 10 is a non-detachable or fixed type one. The tank 10 of the present invention, however, may be constructed detachably. Further, in this embodiment, the tank 10 is fixed to the bed 21. The tank 10 of the present invention, however, may be disposed separately from the bed 21 unless it is connected to the pneumatic cylinders 8 and 9 through pipes, tubes or the like.

If the work of filling the tank 10 with high-pressure gas is done inside the ambulance vehicle 61, this eliminates the need to fill the tank with high-pressure gas prior to the call-out of the ambulance vehicle and also eliminates the need to fill the tank with high-pressure gas after the arrival at the site. Therefore, the ambulance vehicle can be mobilized immediately and ambulance work at the site can be smoothly done. As a result, the convenience of the stretcher 1 can be enhanced.

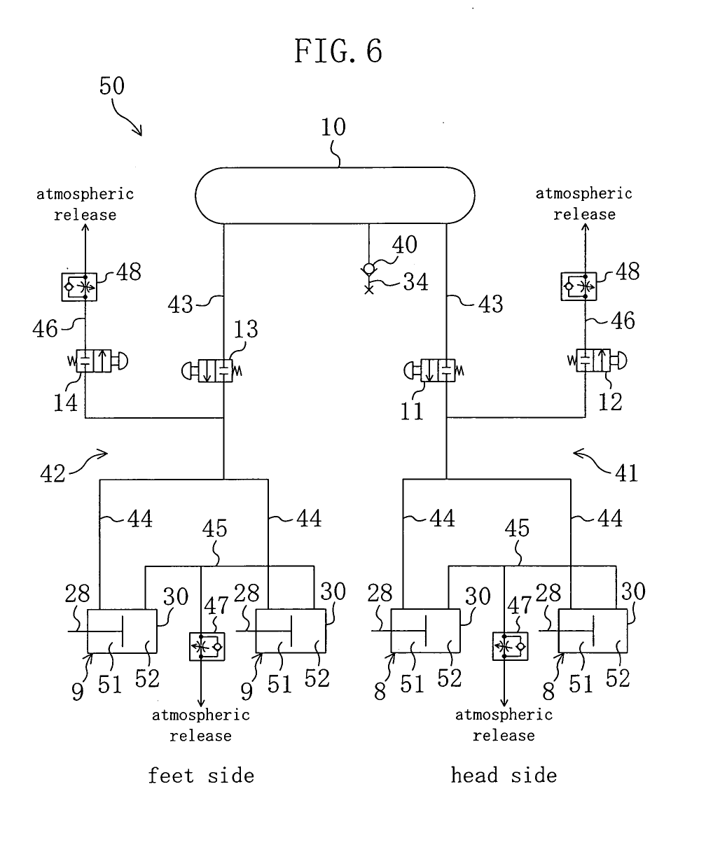

The high-pressure gas piping system in the stretcher 1 is not limited to the piping system 50 (see FIG. 4) in this embodiment. For example, the speed controllers 47, which are carried on the intake pipes 43 in this embodiment, may be carried on the release pipes 45 as shown in FIG. 6. In other words, the release pipes 45 may be provided with speed controllers 47 for controlling the speed of high-pressure gas exhausted from the vented chambers 52, respectively. Also with this structure, the standing speed of the legs 22 can be freely controlled depending on the lifting work of the ambulance officers, which provides the same effects as in the above embodiment.

High-pressure gas used in the stretcher 1 of the above embodiment is not limited to oxygen gas but may be other types of gases such as high-pressure air or nitrogen gas.

The number of pneumatic cylinders 8, 9 for each of the front and rear leg pairs is not limited to two but may be one, three or more. There is no limit to the total number of pneumatic cylinders 8 and 9.

The pneumatic cylinders 8 and 9 in the above embodiment are those of the type which their piston rods 28 retract by introducing high-pressure gas therein. Use can of course be made of pneumatic cylinders of the type which their piston rods extend by introducing high-pressure gas therein.

The speed control means for controlling the ascending or descending speed of the bed 21 are not limited to the speed controllers 47 and 48 but may be other types of speed control means, for example, other mechanical or electrical speed control means.

The above stretcher 1 enhances its convenience by virtue of being equipped with the tank 10. The present invention, however, covers stretchers not equipped with the tank 10. For example, the gas piping system 50 may be provided with a gas inlet through which high-pressure gas can be directly led from a gas source such as a gas container into the piping system 50. Such a stretcher can also exhibit a power assist function using high-pressure gas.

In the above embodiment, pneumatic cylinders 8 and 9 are used as actuators. The actuators used in the above embodiment are not limited to pneumatic cylinders and not particularly limited so long as they can lead high-pressure gas therein and use the high-pressure gas to give the bed 21 an ascending force. For example, a pneumatic motor can be used as an actuator.

The actuator may be of a type which raises the bed 21 by giving the legs 22 forces toward deployment like the above embodiment, or may be of a type which gives the bed 21 an ascending force without giving the legs 22 themselves any forces. For example; an actuator may be adopted which is interposed between the bed 21 and the ground and acts to raise the bed 21 by pushing the ground.

### Embodiment 2

Embodiment 2 is a modified form of the stretcher 1 of Embodiment 1, in which the pneumatic cylinders 8 and 9 are turned ON/OFF in conjunction with the unlocking levers. Further, this embodiment further includes a deactivation device for forcedly deactivating the ascent assist device.

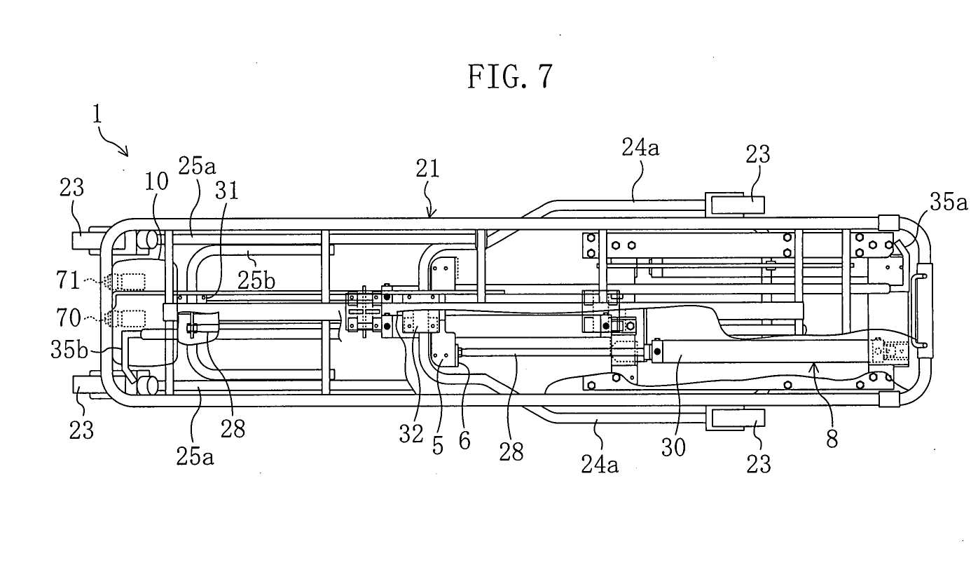

As shown in FIG. 7, the stretcher 1 of Embodiment 2 has substantially the same structure as the stretcher 1 of Embodiment 1. Like Embodiment 1, a head-side unlocking lever 35a is provided at the head side of the bed 21 and a feet-side unlocking lever 35b is provided at the feet side of the bed 21. In Embodiment 2, a main switch 70 and a deactivation switch 71 both for the ascent assist device are also provided at the feet side of the bed 21. The main switch 70 and the deactivation switch 71 are both formed of dial (rotary) switches. The type of the switches 70 and 71, however, is not particularly limited.

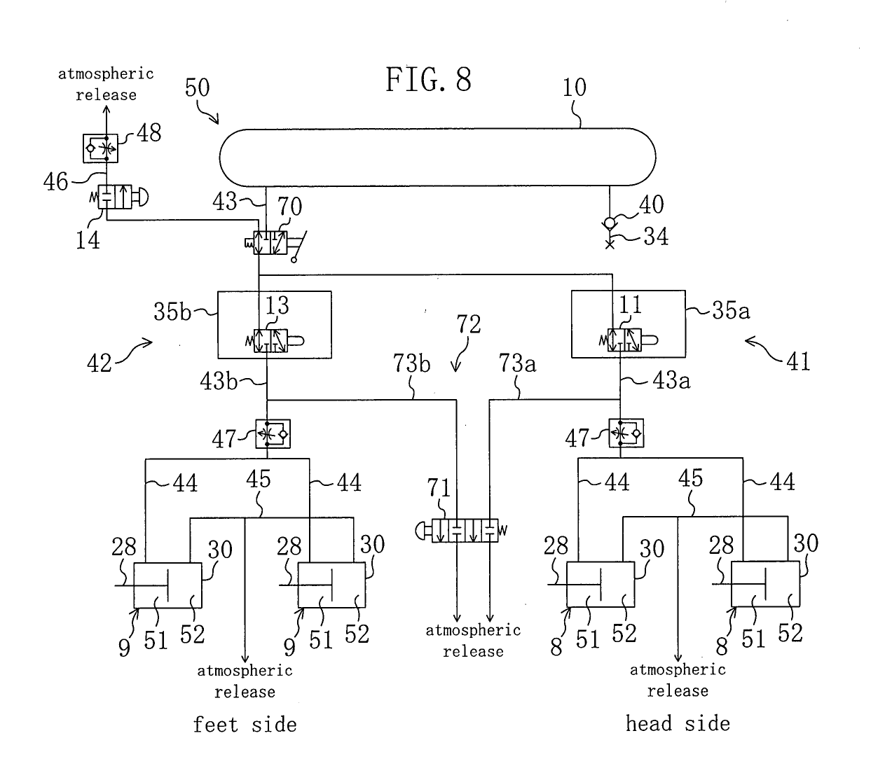

As shown in FIG. 8, the piping system 50 for the stretcher 1 of Embodiment 2 is also made up of a head-side piping system 41 and a feet-side piping system 42. An intake pipe 43 for leading high-pressure gas therein from the tank 10 is provided with the main switch 70 formed of a mechanical valve. The intake pipe 43 is branched into an intake pipe 43a in the head-side piping system 41 and an intake pipe 43b in the feet-side piping system 42. The intake pipe 43a is provided with an intake switch 11 for turning ON/OFF in conjunction with the head-side unlocking lever 35a. On the other hand, the intake pipe 43b is provided with an intake switch 13 for turning ON/OFF in conjunction with the feet-side unlocking lever 35b.

Further, the piping system 50 is equipped with an exhaust pipe 46 for releasing high-pressure gas in the system to the atmosphere. One end of the exhaust pipe 46 is connected to the main switch 70 and the other end is open to the atmosphere. The exhaust pipe 46 is provided, in the order from said one end to the other end, with an exhaust switch 14 formed of a mechanical valve and a speed controller 48.

The structures of part of the intake pipe 43a closer to the pneumatic cylinder 8 and part of the intake pipe 43b closer to the pneumatic cylinder 9 are the same as in Embodiment 1 and therefore the description of them will not be given here.

In this embodiment, the head-side and feet-side intake switches 43a and 43b are connected to atmospheric release pipes 73a and 73b, respectively. One end of the atmospheric release pipe 73a is connected to the intake pipe 43a between the intake switch 11 and the speed controller 47, while the other end is connected to the deactivation switch 71. One end of the atmospheric release pipe 73b is connected to the intake pipe 43b between the intake switch 13 and the speed controller 47, while the other end is connected to the deactivation switch 71. The deactivation switch 71 is a switch for switching atmospheric release back and forth between the atmospheric release pipes 73a and 73b, and is constituted by a mechanical valve. However, the structure of the deactivation switch 71 is not particularly limited. The atmospheric release pipes 73a and 73b and the deactivation switch 71 constitute a deactivation device 72 for deactivating the ascent assist device.

In the operation of raising the bed 21 in this embodiment, the main switch 70 is first turned ON. Then, the head-side and feet-side ambulance officers pull the head-side and feet-side unlocking levers 35a and 35b, respectively. Thus, the intake switches 11 and 13 are turned ON. As a result, high-pressure gas in the tank 10 passes through the intake switches 11 and 13 and the speed controllers 47 and is then introduced into the pressure chambers 51 of the head-side and feet-side pneumatic cylinders 8 and 9. Thus, the pneumatic cylinders 8 and 9 apply to the legs 22 forces toward deployment so that the bed 21 is given an ascending force. Therefore, the ambulance officers can easily lift up the bed 21. After lifting up the bed 21, the ambulance officers release the unlocking levers 35a and 35b to lock the legs 22.

On the other hand, in carrying the stretcher 1 into the ambulance vehicle, the ambulance officer releases the main switch 70 and then turns the exhaust switch 14 ON. Thereafter, the ambulance officer pulls the unlocking lever 35b, thereby turning the intake switch 13 ON. As a result, high-pressure gas in the pressure chambers 51 of the pneumatic cylinders 9 passes through the speed controller 47, the intake switch 13, the main switch 70, the exhaust switch 14 and the speed controller 48 and is then exhausted through the exhaust pipe 46 to the outside. Therefore, the ambulance officer can easily fold the legs 22.

When a failure occurs in the ascent assist device, it is preferable in some cases to deactivate the ascent assist device and implement the ascent of the bed 21 by manual lifting-up work alone. It is also conceivable that when a failure occurs in the ascent assist device, the legs 22 remain receiving forces toward deployment so that they become difficult to fold easily. For example, when a failure occurs in the intake switch 13 after the legs 22 are deployed, high-pressure gas cannot be vented from the pressure chambers 51 of the pneumatic cylinders 9. If such circumstances are left as they are, this makes it difficult to carry the bed 21 into the ambulance vehicle.

To cope with this, in this embodiment, a deactivation mechanism 72 for forcedly deactivating the ascent assist device is provided. Specifically, the intake pipes 43a and 43b are connected to atmospheric release pipes 73a and 73b, respectively, which have a common deactivation switch 71.

In this embodiment, if something wrong happens to the piping system 50, the ambulance officer turns the deactivation switch 71 ON to forcedly release high-pressure gas in the pneumatic cylinders 8 and 9 to the atmosphere through the atmospheric release pipes 73a and 73b. Thus, the high-pressure part of the piping system 50 is open to the outside and the ascent assist device is forcedly deactivated. Therefore, there is no possibility that at the failure, the ascent assist device prevents the ambulance officers work. Hence, if anything goes wrong, the ambulance officers can deploy and fold the legs 22 by manual labor alone. This improves the reliability of ambulance work.

Also in this embodiment, the ascending and descending speeds of the bed 21 can be controlled by the speed controllers 47 and 48, which provides the same effects as in Embodiment 1.

In each of the above embodiments, the ascent assist device is a device that includes the pneumatic cylinders 8 and 9 and gives the bed 21 an ascending force with the use of high-pressure gas. As described already, the ascent assist device provides an advantage of effective utilization of a gas container in the ambulance vehicle. The ascent assist device in the present invention, however, need only be one for giving the bed a sufficient ascending force and is not limited to the device using high-pressure gas.

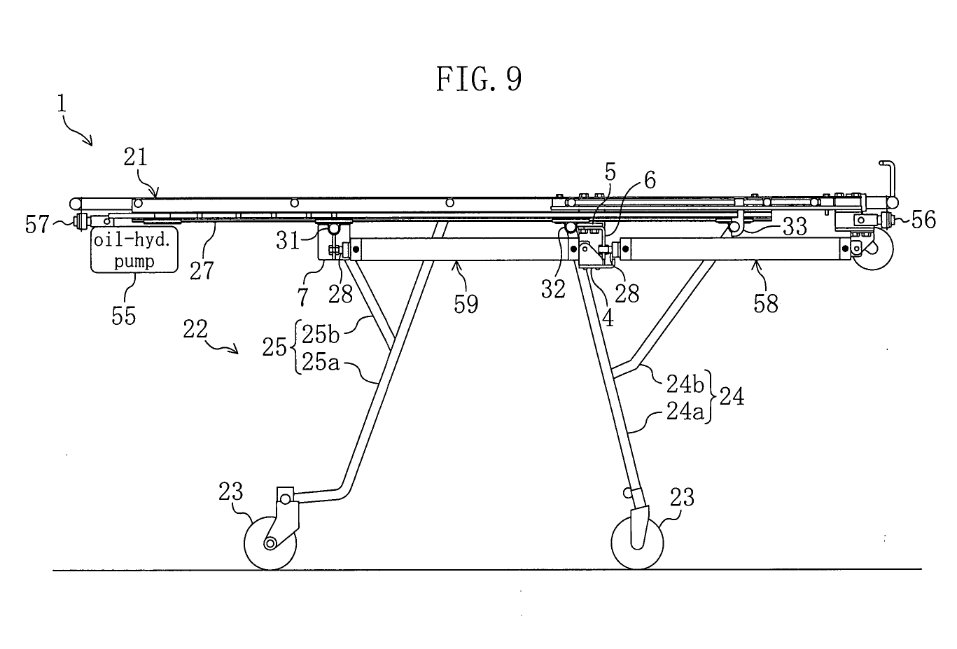

For example, as shown in FIG. 9, an oil-hydraulic ascent assist device may be used. The ascent assist device of this type includes an oil-hydraulic pump 55 instead of the tank 10 for storing high-pressure gas and also includes oil-hydraulic cylinders 58 and 59 instead of pneumatic cylinders 8 and 9. At the head side of the bed 21, a head-side switch 56 is provided fro turning ON/OFF the head-side oil-hydraulic cylinders 58. At the feet side of the bed 21, a feet-side switch 57 is provided for turning ON/OFF the feet-side oil-hydraulic cylinders 59. With this stretcher 1, oil-hydraulic pressure can be used to give the legs 22 forces toward deployment, which allows easy lift-up of the bed 21.

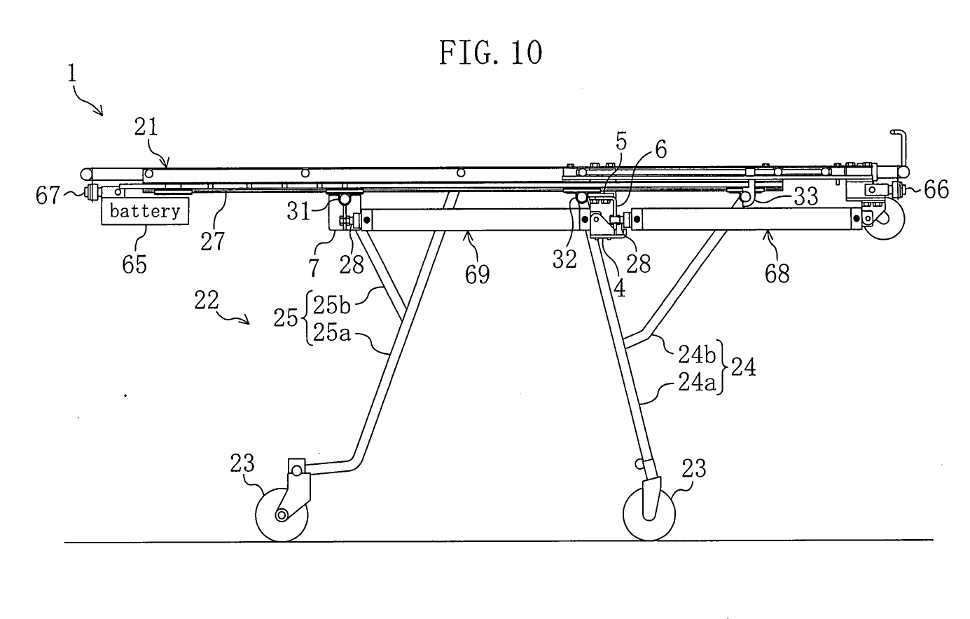

Alternatively, as shown in FIG. 10, a motor-driven ascent assist device may by used. The ascent assist device of this type includes a battery 65 instead of the tank 10 for storing high-pressure gas and also includes motor-driven actuators 68 and 69 instead of pneumatic cylinders 8 and 9. At the head side of the bed 21, a head-side switch 66 is provided for turning ON/OFF the head-side motor-driven actuators 68. At the feet side of the bed 21, a feet-side switch 67 is provided for turning ON/OFF the feet-side motor-driven actuators 69. With this stretcher 1, the motor-driven actuators 68 and 69 can give the legs 22 forces toward deployment, which allows easy lift-up of the bed 21.

Also for each of the above-described ascent assist devices, it is preferable to provide one or both of the speed control means for controlling the ascending speed of the bed 21 and the speed control means for controlling the descending speed of the bed 21. For the ascent assist device using oil-hydraulic pressure, a speed controller in the oil-hydraulic circuit can be preferably used as a speed control means. For the motor-driven ascent assist device, a motor-operated controller can be used as a speed control means. However, the configuration of the speed control means is not particularly limited and various types of controllers can be used as speed control means.

When each of the above ascent assist devices is provided, it is preferable that the ascent assist device is equipped with a deactivation device for forcedly deactivating the ascent assist device. Thus, if anything is wrong with the ascent assist device, the ascent and descent of the bed 21 can be implemented by manual labor alone as the result of deactivation of the ascent assist device.

### Embodiment 3

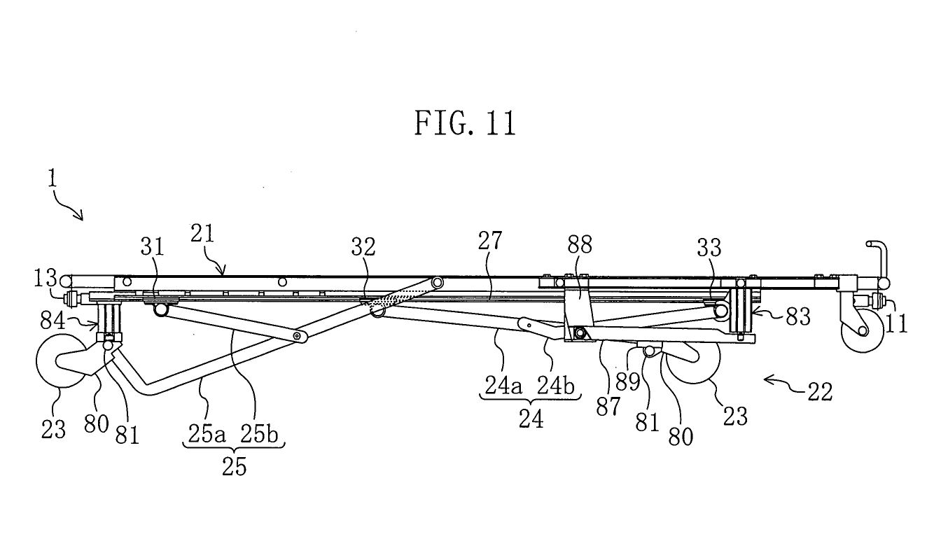

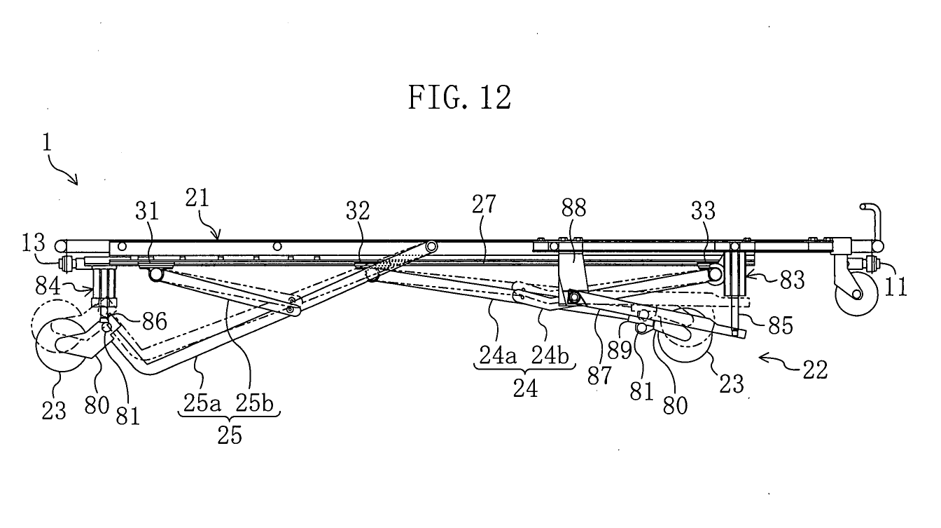

As shown in FIGS. 11 and 12, a stretcher 1 of Embodiment 3 includes a bed 21 on which a sick or injured person will be laid, and legs 22 foldably mounted to the bed 21. Hereinafter, only different elements from Embodiment 1 will be described. The same elements as in Embodiment 1 are indicated by the same reference numerals and description is not given to them.

In these figures, the reference numeral 80 denotes a caster cover 80 attached to the distal end of each of the main legs 24a and 25a of the front and rear legs 24 and 25 to hold the caster 23 rollably. The caster cover 80 is formed with a projection 81 extending sideways (in the front to back direction of the paper in FIGS. 1 and 2).

The stretcher 1 of Embodiment 3 does not have the pneumatic cylinders 8 and 9 as described earlier. This stretcher 1 has a pneumatic cylinder 83 mounted at the head side of the bed 21 and a pneumatic cylinder 84 mounted at the feet side of the bed 21. Each pneumatic cylinder 83, 84 is oriented downward so that its piston rod 85, 86 (see FIG. 12) can move up and down.

The distal end of the piston rod 85 of the head-side pneumatic cylinder 83 is connected to one end of a connecting plate 87. The other end of the connecting plate 87 is pivotally mounted to a support plate 88 fixed to the bed 21. An abutment 89 is attached halfway through the connecting plate 87. The connecting plate 87 is disposed above the projection 81 of the associated head-side caster cover 80 and the abutment 89 comes into contact with the projection 81. As shown in FIG. 11, when the piston rod 85 of the pneumatic cylinder 83 retracts, the connecting plate 87 takes a substantially horizontal position. On the other hand, when the piston rod 85 extends as shown in FIG. 12, the connecting plate 87 takes a position inclined downward toward the front. At this time, the abutment 89 of the connecting plate 87 pushes the projection 81 of the associated caster cover 80 downward, thereby giving the front legs 24 forces toward deployment.

The distal end of the piston rod 86 of the feet-side pneumatic cylinder 84 comes into contact with the projection 81 of the associated feet-side caster cover 80. When the piston rod 86 extends as shown in FIG. 12, the projection 81 of the associated caster cover 80 is pushed downward. As a result, the rear legs 25 are given forces toward deployment.

Thus, in this embodiment, these pneumatic cylinders 83 and 84 constitute an initial ascent assist device for assisting the ascent of the bed 21 in the initial stage of the work of lifting up the bed 21, i.e., in the stage in which the bed 21 is raised from its lowest level to predetermined halfway level. The term halfway level as herein referred to means an arbitrary level between the lowest level (the level when the legs 22 are completely folded) and the highest level (the level when the legs 22 are completely deployed), and does not exactly mean the middle level between them. In this embodiment, the halfway level depends on the amount of extension of the piston rods 85 and 86 of the pneumatic cylinders 83 and 84. Conversely, the halfway level can be arbitrarily selected by controlling the mounting positions of the pneumatic cylinders 83 and 84 and the amount of extension of the piston rods 85 and 86.

The halfway level is preferably a level that the ambulance officers can easily exert some great strength. For example, the height of the waist of the ambulance officer can be set as the halfway level. In addition, the halfway level is preferably a level on and above which the ambulance officers will be less likely to strain their bodies (particularly their backs) when lifting up the bed 21.

The head side of the bed 21 is provided with, as switches for turning the pneumatic cylinder 83 ON/OFF, an intake switch 11 for supplying high-pressure gas to the pneumatic cylinder 83 and an exhaust switch (not shown) for exhausting high-pressure gas in the pneumatic cylinder 83. The intake switch 11 and the exhaust switch are both push-button switches and placed in positions where the buttons are oriented to the front to allow the ambulance officer to easily operate them from the front.

On the other hand, the feet side of the bed 21 is provided with, as switches for turning the pneumatic cylinder 84 ON/OFF, an intake switch 13 for supplying high-pressure gas to the pneumatic cylinder 84 and an exhaust switch (not shown) for exhausting high-pressure gas in the pneumatic cylinder 84. The intake switch 13 and the exhaust switch are also push-button switches and placed in positions where the buttons are oriented to the rear to allow the ambulance officer to easily operate them from the rear.

Note that the switches for turning the pneumatic cylinders 83 and 84 ON/OFF are not limited to the above and various types of switches can be substituted for the above. For example, rotary switches (such as dial switches) or lever-pulling switches may be used. Further, the ON/OFF operation of the pneumatic cylinders 83, 84 may be associated with an unlocking lever or an unlocking lever may double as a switch for the pneumatic cylinders 83, 84.

Though not shown in the figures, the stretcher 1 may be equipped with a high-pressure gas source for supplying high-pressure gas to the pneumatic cylinders 83 and 84. For example, a gas tank for storing high-pressure gas may be installed on the bed 21. In this case, the stretcher 1 may be provided with gas pipes that connect the gas tank to the pneumatic cylinders 83 and 84.

Alternatively, at the ambulance work site, the pneumatic cylinders 83 and 84 may be connected to an external gas source (such as a gas container) and supplied from it with high-pressure gas. In this case, the stretcher 1 is preferably provided with a gas inlet through which high-pressure gas is introduced from the gas source into the pneumatic cylinders 83 and 84. However, high-pressure gas can of course be introduced directly into the pneumatic cylinders 83 and 84.

Next, the usage of the stretcher 1 will be described.

The stretcher 1 is previously on board an ambulance vehicle. When the ambulance vehicle arrives at the site, an ambulance officer takes the stretcher 1 out of the vehicle. In dosing so, the ambulance officer pulls the feet-side unlocking lever and draws the stretcher 1 out of the ambulance vehicle. As a result, the stretcher 1 changes from a position in which the legs 22 are folded to a position in which the legs 22 deploy, so that it can travel on the ground. In this state, the ambulance officer or officers roll the stretcher 1 while pushing or pulling it until they move the stretcher 1 to the vicinity of a sick or injured person.

When the stretcher 1 is moved to the vicinity of the sick or injured person, two ambulance officers carry out operations of lowering and raising the bed 21 while they are present to the front and rear, respectively, of the stretcher 1. In the lowering operation, concurrently with the release of the locking mechanism (not shown) for the legs 22 through the pulling of the unlocking levers, the ambulance officers lower the bed 21. As a result, the legs 22 are folded up. Then, the sick or injured person is laid on the bed 21.

In the raising operation, concurrently with the pulling of the unlocking levers, the ambulance officer present to the front of the stretcher 1 pushes the head-side intake switch 11 and the other ambulance officer present to the rear thereof pushes the feet-side intake switch 13. As a result, high-pressure gas is introduced into the pneumatic cylinders 83 and 84, thereby giving the front and rear legs 24 and 25 forces toward deployment.

Concurrently with or after the pushing of the intake switches 11 and 13, the ambulance officers lift the bed 21 up to the halfway level (in the initial stage of the lifting work). At the time, since the pneumatic cylinders 83 and 84 give the front and rear legs 24 and 25 forces toward deployment, the ambulance officers can lift up the bed 21 with small strengths. If the pressure of high-pressure gas introduced into the pneumatic cylinders 83 and 84 is increased, the bed 21 can be raised up to the halfway level without the need for the ambulance officers to lift up the bed 21. In other words, the ascent up to the halfway level can be fully automated.

After the bed 21 is lifted up to the halfway level, the bed 21 is raised up to the highest level by further lifting up the bed 21 (in the later stage of the lifting work). As a result, the legs 22 becomes deployed. When the unlocking levers are released in this state, the locking mechanism acts so that the legs 22 are held deployed. Thereafter, the ambulance officers carry the stretcher 1 into the ambulance vehicle.

As described above, the stretcher 1 has a power assist function for assisting the ambulance officers in lifting up the bed 21 in the initial stage of the lifting work. Specifically, while the ambulance officers lift up the bed 21, the pneumatic cylinders 83 and 84 apply large forces toward deploying the legs 22 to the stretcher 1 so that large upward forces can be given to the bed 21. Therefore, the physical burdens of the ambulance officers can be extensively reduced in the initial stage where they are forced to stoop to do the lifting work. This makes it possible for even an ambulance officer with less muscle to smoothly lift up the bed 21. In addition, the ambulance officers can reduce their fatigue due to the lifting work and can be prevented from straining their bodies (for example, their backs).

Since pneumatic cylinders 83 and 84 are used as an initial ascent assist device, the initial ascent assist device can be constructed relatively simply. In addition, since the structure and behavior of the device are simple, this provides a highly reliable initial ascent assist device.

If the stretcher 1 is equipped with a gas source for storing high-pressure gas (such as a gas tank), this eliminates the need for an additional gas source, which allows free operation of the pneumatic cylinders 83 and 84 at any time at the site where the stretcher 1 has been carried.

The type of high-pressure gas used in the stretcher 1 is not particularly limited. For example, oxygen gas, high-pressure air or nitrogen gas can be suitably used.

The number of pneumatic cylinders for each of the head and feet sides is not limited to one but may be two or more.

In the above embodiment, pneumatic cylinders 83 and 84 are used as an initial ascent assist device. The device used in the above embodiment may be of other types which can lead high-pressure gas therein and give the bed 21 an ascending force using the high-pressure gas. For example, pneumatic motors can be used as an initial ascent assist device.

The initial ascent assist device in this invention may be of a type which raises the bed 21 by giving the legs 22 forces toward deployment or may be of a type which raises the bed 21 without giving the legs 22 themselves any forces. For example, an initial ascent assist device may be adopted which is interposed between the bed 21 and the ground and acts to raise the bed 21 by pushing the ground.

If the bed 21 is abruptly raised, the sick or injured person laid on the bed 21 is likely subjected to a shock. To avoid this, the initial ascent assist device may be provided with a speed control means for controlling the ascending speed of the bed 21. For example, a speed controller (speed control valve) may be disposed in the high-pressure gas piping system for the pneumatic cylinders 83 and 84. This reduces the sick or injured person's stress.

### Embodiment 4

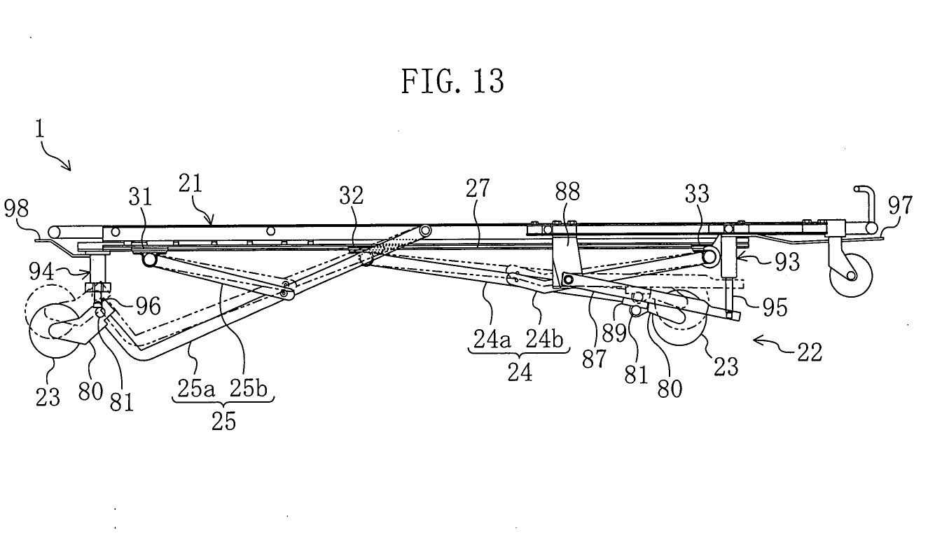

As shown in FIG. 13, the stretcher 1 of Embodiment 4 includes as an initial ascent assist device pneumatic cylinders 93 and 94 with a built-in manual pump, instead of pneumatic cylinders 83 and 84 in Embodiment 3.

The head-side pneumatic cylinder 93 is provided with a boosting lever 97. The boosting lever 97 extends frontward beyond the bed 21. Thus, the ambulance officer present to the head side can operate the boosting lever 97 by foot (i.e., manipulate the boosting lever 97 by stepping on it by foot). Therefore, the pressure in the cylinder can be easily raised to easily extend the piston rod 95.

The feet-side pneumatic cylinder 94 is also provided with a boosting lever 98 extending rearward. Therefore, the ambulance officer present to the feet side can also operate the boosting lever 98 by foot, thereby easily raising the pressure in the cylinder and easily extending the piston rod 96.

The other parts of the structure are the same as in Embodiment 3 and therefore description will not be given to them.

As described above, in this embodiment, the pneumatic cylinders 93 and 94 can be operated by foot to easily raise the bed 21 in the initial stage of the lifting work. Therefore, like Embodiment 3, the physical burdens of the ambulance officers can be reduced in the initial stage of the lifting work.

In addition, according to this embodiment, the ascending speed of the bed 21 can be easily controlled by controlling the operating speed of the boosting levers 97 and 98. Therefore, in the initial stage of the lifting work, the lifting work can be smoothly done without giving the sick or injured person on the bed 21 an excessive physical burden.

### Embodiment 5

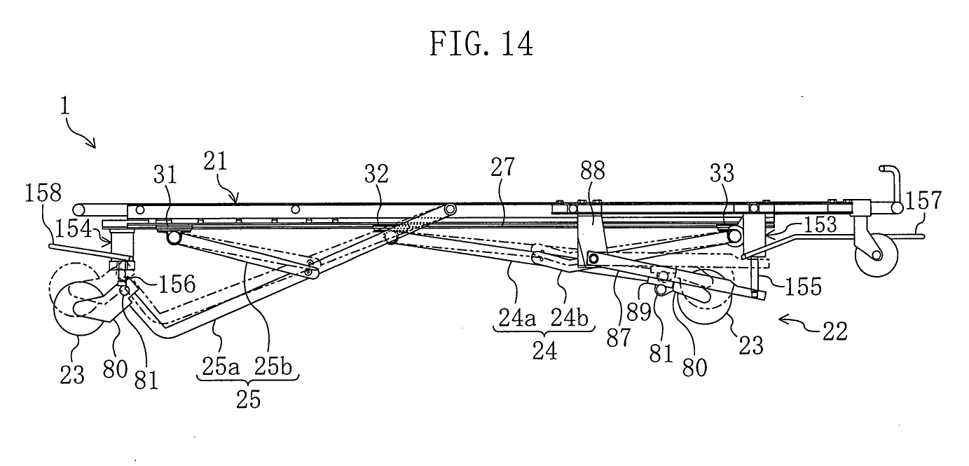

As shown in FIG. 14, the stretcher 1 of Embodiment 5 includes as an initial ascent assist device hydraulic cylinders 153 and 154 with a built-in manual pump, instead of pneumatic cylinders 83 and 84 in Embodiment 3.

The head-side and feet-side hydraulic cylinders 153 and 154 are provided with boosting levers 157 and 158 for raising the hydraulic pressures in the cylinders, respectively. Like Embodiment 2, the head-side boosting lever 157 extends frontward beyond the bed 21 and the feet-side boosting lever 158 extends rearward beyond the bed 21. Thus, the ambulance officers present to the head and feet sides can operate the boosting levers 157 and 158, respectively, to extend the piston rods 155 and 156 of the hydraulic cylinders 153 and 154.

The other parts of the structure are the same as in Embodiment 3 and therefore description will not be given to them.

Also in this embodiment, in the initial stage of the lifting work, the hydraulic cylinders 153 and 154 can be operated by foot to easily raise the bed 21. Therefore, the physical burdens of the ambulance officers can be reduced, which provides the same effects as in Embodiment 1.

Also in this embodiment the ascending speed of the bed 21 can be easily controlled by controlling the operating speed of the boosting levers 157 and 158. Therefore, in the initial stage of the lifting work, the lifting work can be smoothly done without giving the sick or injured person on the bed 21 an excessive physical burden.

### Embodiment 6

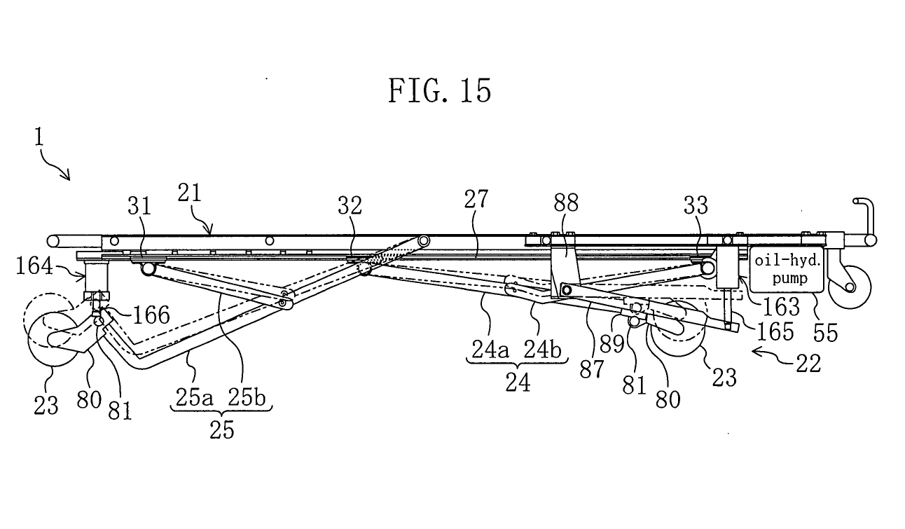

As shown in FIG. 15, the stretcher 1 of Embodiment 6 includes as an initial ascent assist device oil-hydraulic cylinders 163 and 164 with piston rods 165 and 166, respectively, instead of pneumatic cylinders 83 and 84 in Embodiment 3.

At the head side of the bed 21, an oil-hydraulic pump 55 is provided for supplying oil into the oil-hydraulic cylinders 163 and 164. Note that though the oil-hydraulic pump 55 is provided at the head side in this embodiment, its shape, size and mounting position are not particularly limited. Though not shown, the bed 21 is provided with an intake switch and an exhaust switch both for turning the hydraulic cylinders 163 and 164 ON/OFF. The types of the intake and exhaust switches are not particularly limited. For example, the like elements as the intake switch 11, 13 and the exhaust switch in Embodiment 3 can be suitably used.

The other parts of the structure are the same as in Embodiment 3 and therefore description will not be given to them.

Also in this embodiment, in the initial stage of the lifting work, oil-hydraulic pressure can be used to apply a large ascending force to the bed 21. Therefore, the physical burdens of the ambulance officers can be reduced thereby providing the same effects as in Embodiment 3.

Also in this embodiment, like Embodiment 3, it is preferable to provide a speed control device for controlling the ascending speed of the bed 21.

### Embodiment 7

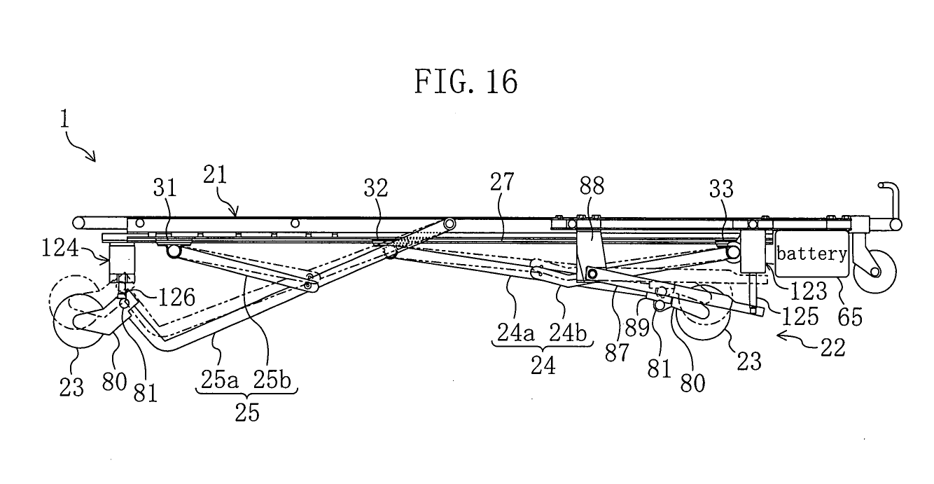

As shown in FIG. 16, the stretcher 1 of Embodiment 7 includes as an initial ascent assist device motor-driven actuators 123 and 124, instead of the pneumatic cylinders 83 and 84 in Embodiment 3.

The motor-driven actuators 123 and 124 have extendable and retractable rods 125 and 126, respectively. Like the piston rod 85 in Embodiment 3, the distal end of the rod 125 is connected to the connecting plate 87. Further, like the piston rod 86 in Embodiment 3, the distal end of the rod 126 comes into contact with the projection 81 of the associated caster cover 80 for one rear leg 25.

At the head side of the bed 21, a battery 65 is provided for supplying electricity to the motor-driven actuators 123 and 124. Note that though the battery 65 is provided at the head side in this embodiment, its shape, size and mounting position are not particularly limited. Though not shown, the bed 21 is provided with a switch for turning the motor-driven actuators 123 and 124 ON/OFF.

The other parts of the structure are the same as in Embodiment 3 and therefore description will not be given to them.

According to this embodiment, in the initial stage of the lifting work, the motor-driven actuators 123 and 124 can apply a large ascending force to the bed 21. Therefore, the physical burdens of the ambulance officers can be reduced thereby providing the same effects as in Embodiment 3.

Also in this embodiment, it is preferable to provide a speed control device for controlling the ascending speed of the bed 21.

### Embodiment 8

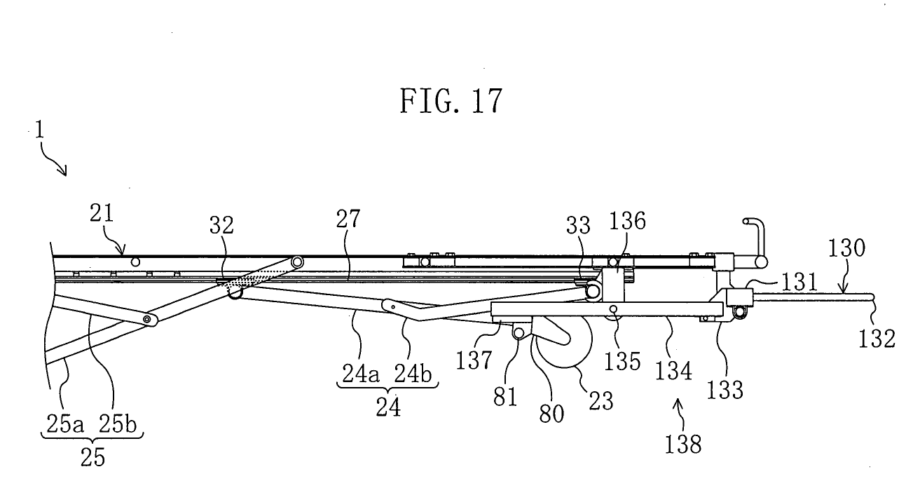

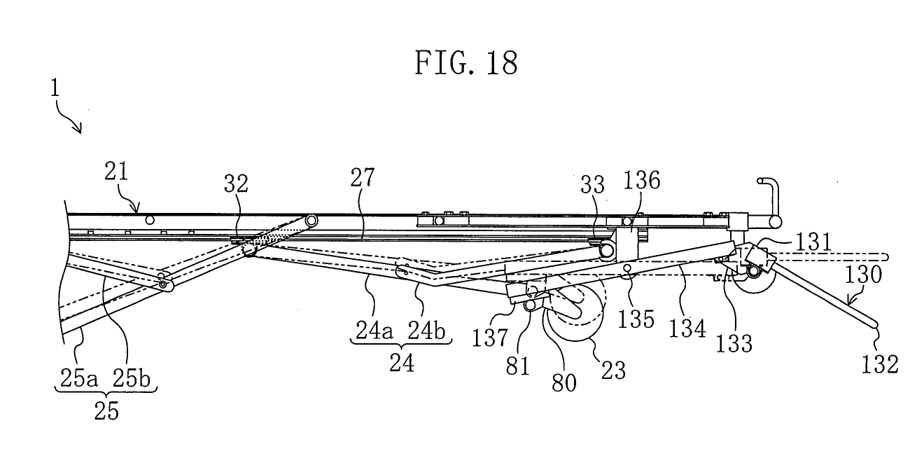

As shown in FIGS. 17 and 18, the stretcher 1 of Embodiment 8 includes as an initial ascent assist device a treadle lever 130 and a link mechanism 138 for converting a force of angular movement of the treadle lever 130 to an ascending force of the bed 21, instead of the pneumatic cylinders 83 and 84 in Embodiment 3.

The bed 21 is provided with a downwardly extending mounting plate 136. A pin 135 is provided at the distal end of the mounting plate 136. A connecting plate 134 is pivotally supported at an intermediate point to the pin 135. An abutment 137 contactable with the projection 81 of the associated caster cover 80 is fixed to the rear end of the underside of the connecting plate 134. The front end of the connecting plate 134 is supported pivotally to a connecting plate 133.

The treadle lever 130 provided at the head side extends frontward beyond the bed. The root part of the treadle lever 130 forms a mounting part 131 pivotally mounted to the connecting plate 133. The distal part of the treadle lever 130 is formed in a bar extending laterally (in the front to back direction of the paper in FIGS. 17 and 18), and forms a pedal 132 which will be stepped on by an ambulance officer in the lifting work.

When an ambulance officer steps on the pedal 132, the treadle lever 130 turns forwardly downward. The forwardly downward turn of the treadle lever 130 causes the connecting plate 134 to turn about the pin 135 as a pivotal point and thereby tilt forwardly upward. At this moment, the abutment 137 of the connecting plate 134 pushes down the projection 81 of the associated caster cover 80. As a result, the front legs 24 receives forces toward deployment so that the bed 21 is given an ascending force. As can be seen from this, the connecting plates 133 and 134 constitute a link mechanism 138 for converting a turning force of the treadle lever 130 to an ascending force of the bed 21 (a force to raise the bed 21).

Though not shown, the same link mechanism 138 is also provided at the feet side of the bed 21.

In the initial stage of the work of lifting up the bed 21, the ambulance officer steps on the treadle lever 130 by feet as well as using his own weight, thereby pushing down the distal part of the treadle lever 130. Thus, the ambulance officers can easily lift up the bed 21 to the halfway level without stooping. In addition, since the force obtained by stepping is greater than the lifting force by hands, the ambulance officers can exert greater strengths.

Therefore, also in this embodiment, the bed 21 can be easily raised to the halfway level without imposing large physical burdens on the ambulance officers.

In this embodiment, if the treadle lever 130 is slowly stepped on, the bed 21 can be raised little by little. Therefore, the lifting work can be smoothly implemented without possibility of large physical burden on the sick or injured person on the bed 21.

### Embodiment 9

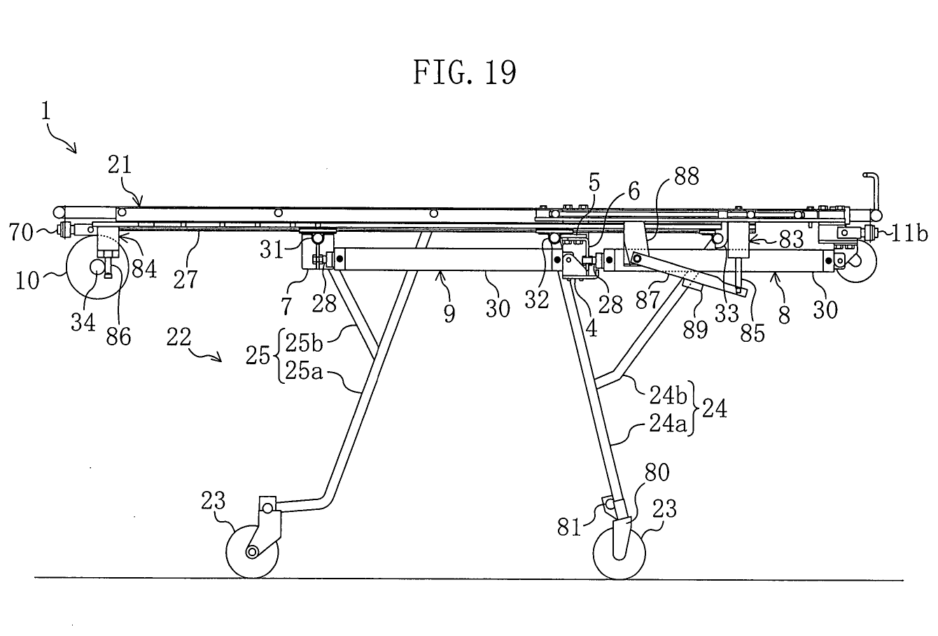

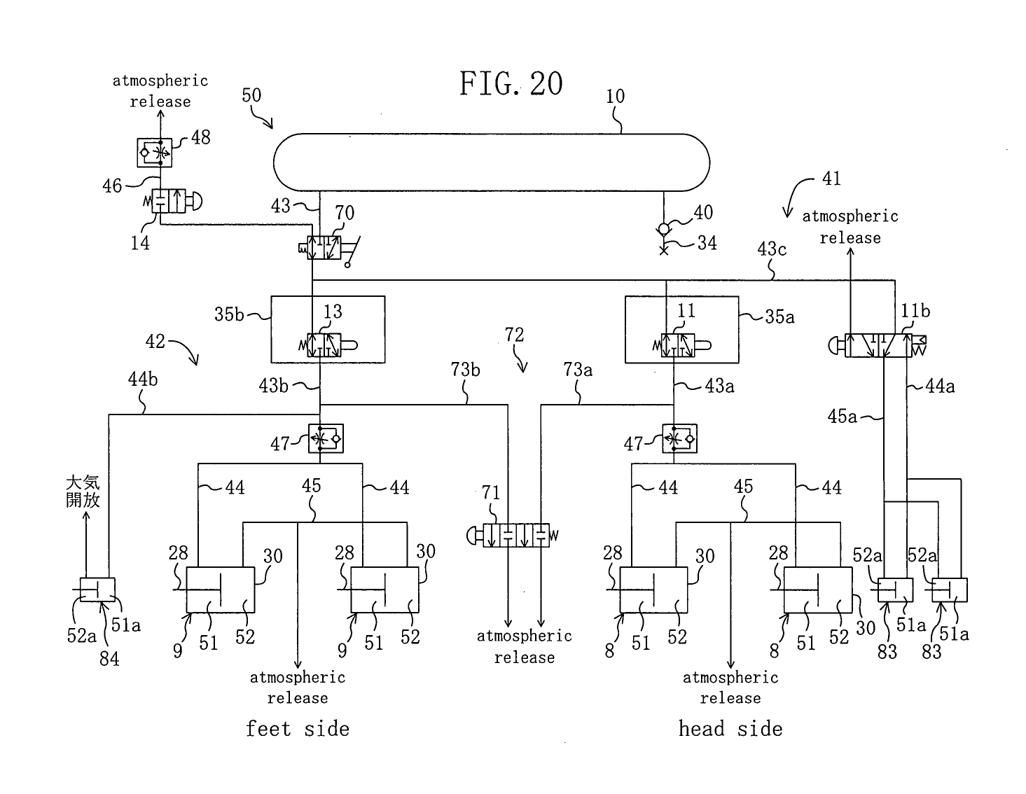

As shown in FIGS. 19 and 20, a stretcher 1 of Embodiment 9 is a combination of Embodiments 2 and 3. In other words, in this embodiment, a main ascent assist device for assisting the lifting work of the bed 21 in all stages of the lifting work is added to the structure of the stretcher of Embodiment 3.

As shown in FIG. 19, on the bottom of the bed 21, a pair of head-side right and left pneumatic cylinders 8 and a pair of feet-side right and left pneumatic cylinders 9 are mounted. As described before, the piston rods 28 of the head-side pneumatic cylinders 8 are secured to a common slider 32 through drawing plates 6, respectively, and a common drawing block 5, while the piston rods 28 of the feet-side pneumatic cylinders 9 are secured to a common slider 31 through drawing plates 7, respectively.

FIG. 20 shows a piping diagram for high-pressure gas. The piping system 50 is, as in Embodiment 2 (see FIG. 8), composed of a head-side piping system 41 for controlling head-side pneumatic cylinders 8, 83 and a feet-side piping system 42 for controlling feet-side pneumatic cylinders 9, 84.

A different point from the piping system in Embodiment 2 is that the head-side piping system 41 contains a pipeline for operating the pneumatic cylinders 83. Specifically, the head-side piping system 41 includes an air intake/exhaust switch 11b formed of a mechanical valve, an intake pipe 43c connecting the intake pipe 43a and the air intake/exhaust switch 11b, an intake pipe 44a connecting the air intake/exhaust switch 11b and each of the pressure chambers 51a of the pneumatic cylinders 83, and a release pipe 45a connecting the air intake/exhaust switch 11b and each of the vented chambers 52a of the pneumatic cylinders 83. One end of the intake pipe 43c is connected in the intake pipe 43a between the main switch 70 and the intake switch 11.

Further, one end of an intake pipe 44b is connected in the intake pipe 43b of the feet-side piping system 42 between the intake switch 13 and the speed controller 47. The other end of the intake pipe 44b is connected to the pressure chamber 51a of the pneumatic cylinder 84.

In the operation of raising the bed 21 in this embodiment, the main switch 70 is first turned ON. Then, the air intake/exhaust switch 11b is turned ON and the head-side and feet-side ambulance officers pull the head-side and feet-side unlocking levers 35a and 35b, respectively. Thus, the locking mechanism for the legs 22 are released so that the intake switches 11 and 13 are turned ON. As a result, high-pressure gas in the tank 10 is introduced into the pressure chambers 51a of the pneumatic cylinders 83 and 84 as well as the pressure chambers 51 of the pneumatic cylinders 8 and 9. Thus, the pneumatic cylinders 83 and 84 as well as the pneumatic cylinders 8 and 9 apply to the legs 22 forces toward deployment in the initial stage of the lifting work, and then the pneumatic cylinders 8 and 9 apply to the legs 22 forces toward deployment in the later stage of the lifting work. In this manner, the bed 21 is given an ascending force. Therefore, the ambulance officers can easily lift up the bed 21. After lifting up the bed 21, the ambulance officers release the unlocking levers 35a and 35b to lock the legs 22.

As described above, the stretcher 1 has a power assist function for assisting the ambulance officers in lifting up the bed 21 in all stages of the lifting work. Therefore, the physical burdens of the ambulance officers can be extensively reduced. This makes it possible for even an ambulance officer with less muscle to smoothly lift up the bed 21. In addition, the ambulance officers can reduce their fatigue due to the lifting work and can be prevented from straining their bodies (for example, their backs).

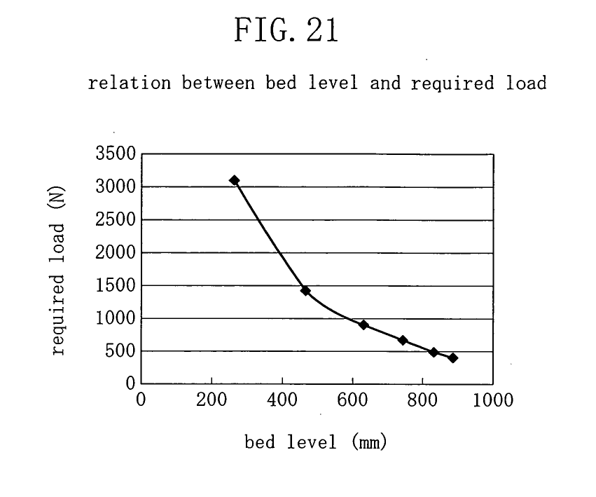

With, as in this embodiment, stretchers which raise the bed 21 by deploying the legs 22, the load required to deploy the legs 22 is large particularly in the initial stage of the lifting work. Specifically, as shown in FIG. 21, the required load is largest when the bed 21 is at the lowest level and is sharply decreased with the ascent of the bed 21. This relation between the required load and the level of the bed 21 is derived from the foldable structure of the legs 22. The ascending direction of the bed 21 is the vertical direction and the component of the force toward deploying the legs 22 which contributes to the ascent of the legs 22 is limited to a vertical component force acting along the longitudinal direction of the main legs 24a and 25a. Therefore, when the bed 21 is still at a low level, the legs 22 have not yet sufficiently stood up. At this time, only a small vertical component force acts on them, which requires a large load to stand up the legs 22. On the other hand, when the bed 21 reaches a high level, the bed 22 has stood up to some degree. At this time, the vertical component force acting on the legs 22 becomes large and therefore the required load becomes small.

As can be understood from above, if the stretcher includes only a main ascent assist device as an ascent assist device, the device should be a relatively large-capacity ascent assist device that can exert a large load required in the initial lifting stage. However, if the main ascent assist device is combined with the initial ascent assist device as in this embodiment, the required load of the main ascent assist device can be reduced to a small extent. Thus, the main ascent assist device can be reduced in size and capacity.

Note that the high-pressure piping system for the above stretcher 1 is not limited to the above-described piping system 50 (see FIG. 20).

The actuators for the main ascent assist device are not limited to pneumatic cylinders but may be other types of actuators for giving the bed 21 an ascending force using high-pressure gas. For example, pneumatic motors can be used as actuators for the main ascent assist device.

The actuators are not limited to those using high-pressure gas but may be actuators using other types of drive sources. For example, oil-hydraulic or motor-driven actuators are also applicable.

The above actuators may be those giving an ascending force just to the bed 21.

The main ascent assist device may be combined with the initial ascent assist device in any one of Embodiments 4 to 9.

### Embodiment 10

Embodiment 10 relates to a system comprising a stretcher 1 and a vibration isolation platform 100.

The stretcher 1 in Embodiment 10 is substantially the same as that of Embodiment 2. Therefore, description will be made with reference to FIG. 7 and detailed description will not be given.

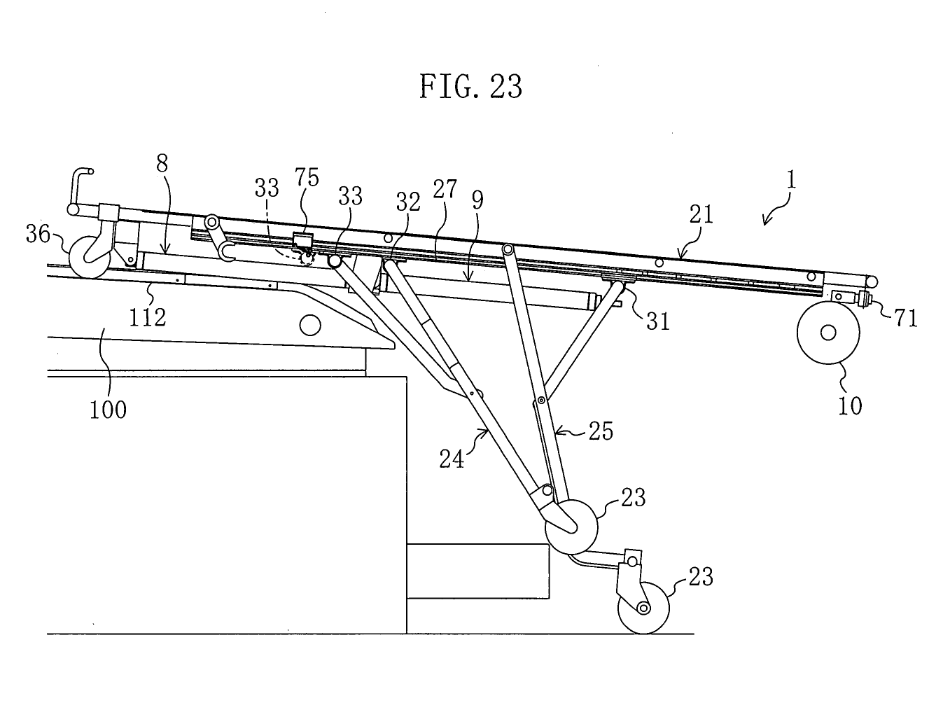

The stretcher 1 of Embodiment 10 is different from that of Embodiment 2 in that on the bottom of the bed 21, a limit switch 75 (see FIG. 23) is provided which is turned ON/OFF by a slider 33 slidable on a rail 27. The mounting position and behavior of the limit switch 75 will be described later.

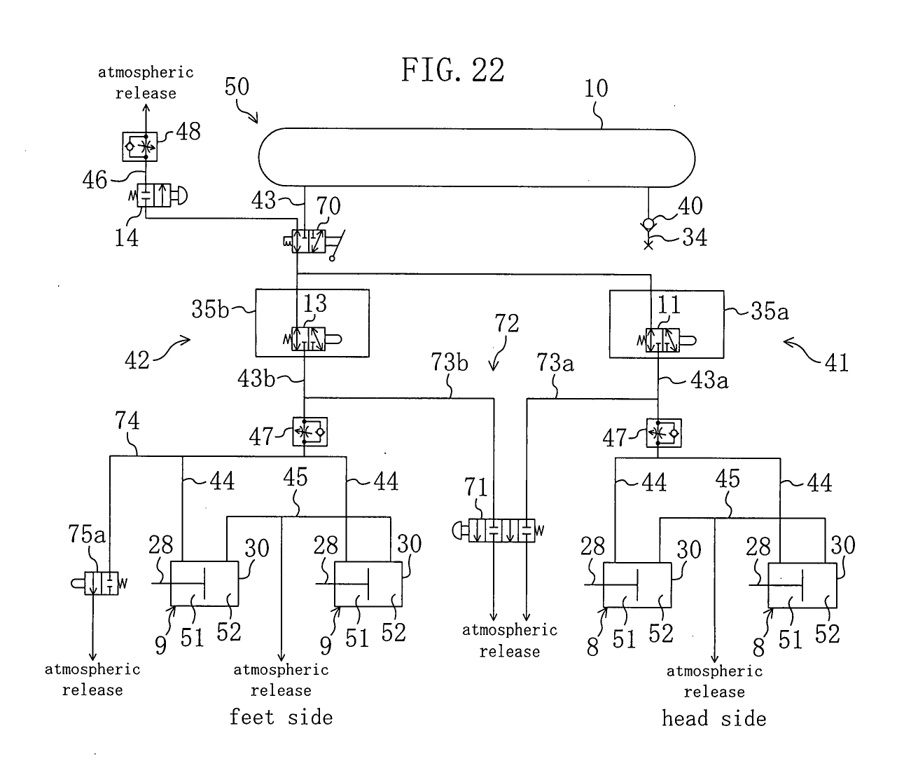

FIG. 22 shows a piping diagram for high-pressure gas. The piping system 50 is, as in Embodiment 2, composed of a head-side piping system 41 for controlling head-side pneumatic cylinders 8 and a feet-side piping system 42 for controlling feet-side pneumatic cylinders 9.

The piping system in this embodiment is different from that in Embodiment 2 in that an exhaust pipe 74 is connected to the branch pipe 44 of the feet-side piping system 42. The exhaust pipe 74 is connected with a changeover switch 75a formed of a mechanical valve. This changeover switch 75a is connected to the limit switch 75 and configured to change over by the turning ON/OFF of the limit switch 75.

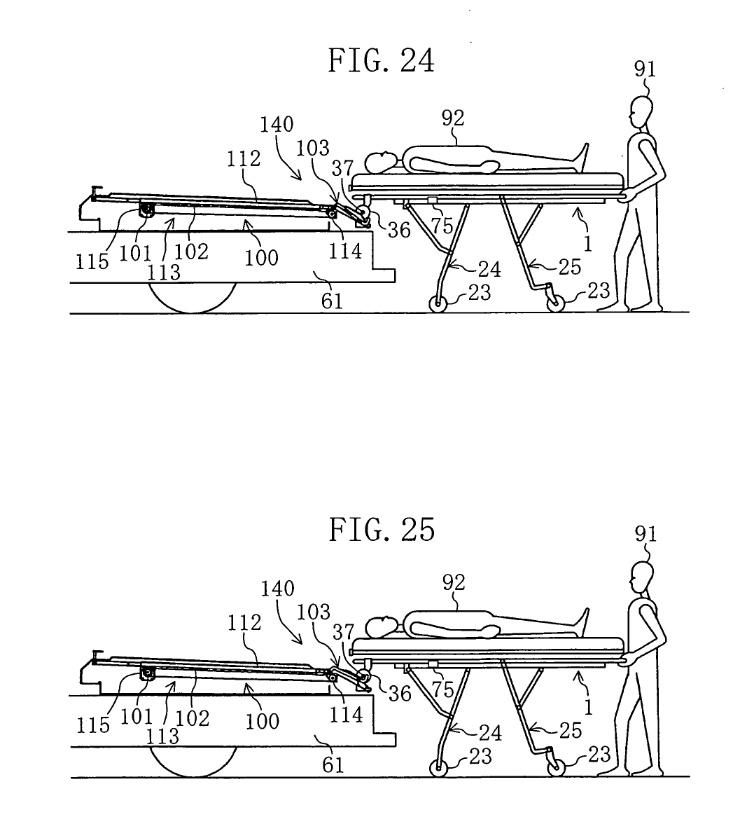

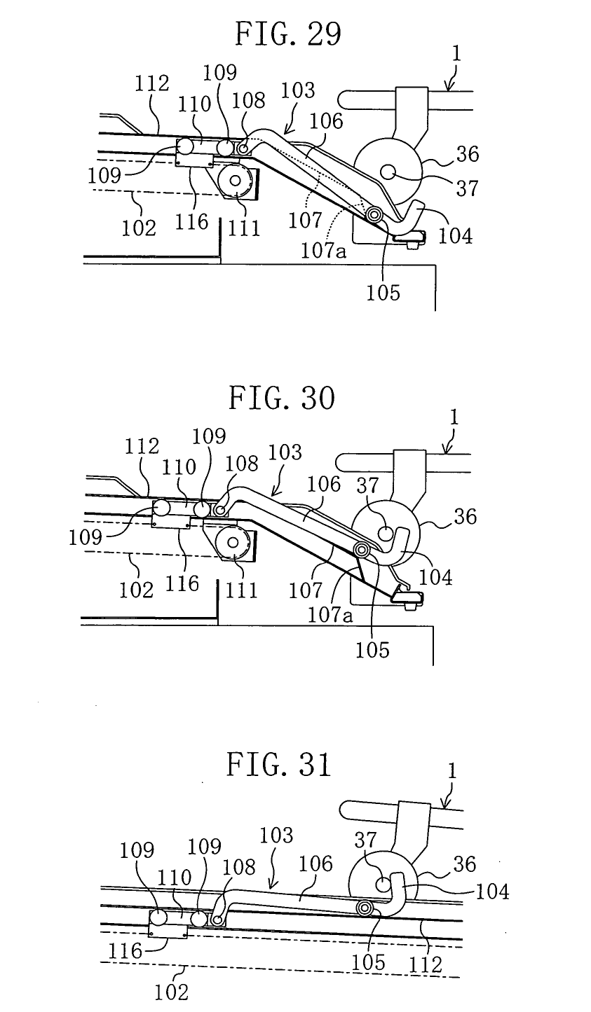

Next, description will be made of the structure of the vibration isolation platform 100 on which the stretcher 1 is to be put with reference to FIGS. 24 and 29.

In this embodiment, use is made of the vibration isolation platform 100 equipped with a conveyer for automatically drawing the stretcher 1. Note that the vibration isolation platform 100 is not limited to the particular type but various types of vibration isolation platforms can be used. Here, use is made of the vibration isolation platform disclosed in Japanese Unexamined Patent Publication No. 2002-153512. A brief description will be made below of the structure of the vibration isolation platform 100.

As shown in FIG. 24, the vibration isolation platform 100 is installed in the ambulance vehicle 61. The vibration isolation platform 100 is equipped with a hook carriage 103 for drawing the stretcher 1, a guide rail 112 for guiding the hook carriage 103, and a hook carriage drive mechanism 113 for moving the hook carriage 103 along the guide rail 112. The hook carriage 103 and the hook carriage drive mechanism 113 constitutes a conveyer 140 for carrying the stretcher 1 onto the vibration isolation platform 100.

The hook carriage drive mechanism 113 includes two sprocket wheels 101 and 114 a predetermined distance spaced apart from each other in the front to rear direction (right to left direction in FIG. 24), an endless chain 102 wrapped around the sprocket wheels 101 and 114, and a driving gear 115 for rotating the sprocket wheel 101. The hook carriage 103 is attached to the chain 102. Therefore, when the driving gear 115 rotates the sprocket wheel 101, the chain 102 travels so that the hook carriage 103 attached to the chain 102 moves backward and forward.

As shown in FIG. 29, the hook carriage 103 is provided with a roller 109 for rolling in and along the guide rail 112, and a mounting piece 116 to which the chain 102 is attached. A hook 106 is pivotally attached to one end of the hook carriage 103 via a shaft 108. A hook guide roller 105 is provided at part of the hook 106 toward the distal end thereof. The distal end 104 of the hook 106 is bent upward in an L-shape. Therefore, the distal end of the hook 106 is formed to engage the shaft 37 of a carrying-in/out guide roller 36 provided at the front end of the stretcher 1.

A hook guide rail 107 is provided at the rear end of the guide rail 112 (right end thereof in FIG. 29). The hook guide rail 107 inclines gently downward from the guide rail 112 toward its rear end and the rear end has a large angle of inclination to form a sharp inclined surface 107a.

With this structure, the hook carriage 103 automatically engages the stretcher 1 in the carrying-in of the stretcher 1. Further, in the carrying-out of the stretcher 1, the hook carriage 103 automatically releases the engagement with the stretcher 1.

Specifically, in the carrying-in of the stretcher 1, the hook carriage 103 goes forward so that the hook guide roller 105 moves forward on the sharp inclined surface 107a of the hook guide rail 107. With the advance of the hook guide roller 105, the hook 106 pivots upward so that the distal end 104 of the hook 106 is raised up to a level higher than the shaft 37 of the stretcher 1. Then, the hook 106 engages the shaft 37 of the stretcher 1 (see FIG. 30). Thereafter, with the advance of the hook carriage 103, the stretcher 1 is drawn forward (see FIG. 31).

On the other hand, in the carrying-out of the stretcher 1, the hook carriage 103 moves toward the rear end of the guide rail 112 along the guide rail 112 so that the hook guide roller 105 transfers from the guide rail 112 to the hook guide rail 107. Then, after the hook guide roller 105 reaches the sharp inclined surface 107a of the hook guide rail 107, the hook 106 gradually downwardly pivots with the downward movement of the hook guide roller 105 along the inclined surface 107a. Finally, the distal end 104 of the hook 106 goes down to below the shaft 37. As a result, the engagement of the hook 106 is automatically released.

The operations of lowering and raising the bed 21 of the stretcher 1 in this embodiment are the same as in Embodiment 2. Therefore, description will not given to them. Here, description will be made of the operation for carrying the stretcher 1 on the vibration isolation platform 100 in the ambulance vehicle 61.

First, the ambulance officer 91 drives the driving gear 115 of the vibration isolation platform 110 to move the hook carriage 103 to the rear end of the guide rail 112. Next, as shown in FIGS. 24 and 29, the ambulance officer 91 positions the stretcher 1 such that the shaft 37 of the carrying-in/out guide roller 36 of the stretcher 1 comes to above the hook distal end 104 of the hook carriage 103.

Next, the ambulance officer 91 drives the driving gear 115 in the reverse direction to move the hook carriage 103 forward. Thus, as shown in FIGS. 25 and 30, the hook 106 engages with the shaft 37 of the carrying-in/out guide roller 36 of the stretcher 1 so that the stretcher 1 can be drawn by the hook carriage 103.

At this time, the ambulance officer 91 pulls the unlocking lever 35b of the stretcher 1 to release the legs 22 from their locking state. The unlocking lever 35b is configured to release both the locking mechanisms for the front and rear legs 24 and 25. Since the pressure chambers 51 of the pneumatic cylinders 8 and 9 are filled with high-pressure gas, an ascending force is applied to the bed 21 even if the lock of the legs 22 is released. Therefore, the ambulance officer 91 can support the bed 21 with small strength. If the pressure of high-pressure gas in the pneumatic cylinders 8 and 9 is set relatively high, the raised position of the bed 21 can be kept even if the ambulance officer 91 applies any force to the bed 21.

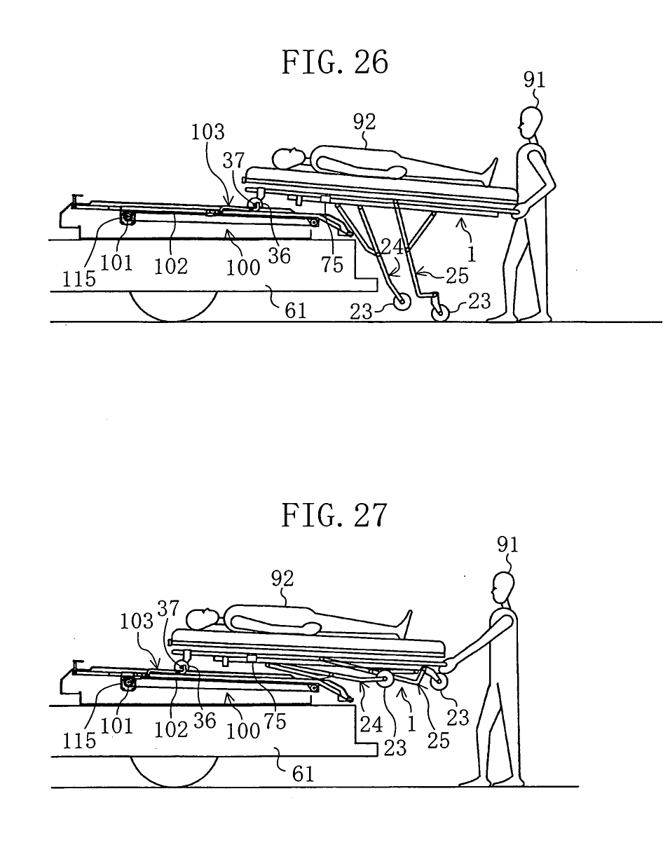

Next, as shown in FIG. 26, when the drawing of the hook carriage 103 proceeds, the front legs 24 of the stretcher 1 abut on the rear end of the vibration isolation platform 100. Then, during further forward movement of the stretcher 1, the front legs 24 receive a backward force from the rear end of the vibration isolation platform 100 and is thereby automatically folded up.

As shown in FIG. 23 (where the hook carriage 103 is not given in FIG. 5), with the folding motion of the front legs 24, the slider 33 at the front side of the stretcher 1 moves backward. Then, when the length of part of the stretcher 1 laid on the platform reaches a predetermined value, the slider 33 passes through the limit switch 75 as shown in the dot-dash line in FIG. 23 to turn the limit switch 75 ON. Thus, the changeover switch 75a (see FIG. 22) is changed over. As a result, high-pressure gas stored in the pressure chambers 51 of the feet-side pneumatic cylinders 9 is discharged through the exhaust pipe 74 to the outside. Thus, the rear legs 25 become foldable.

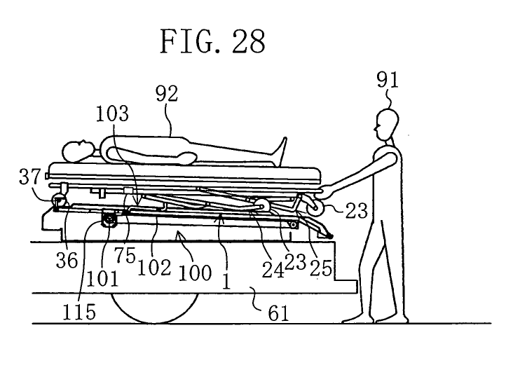

Thereafter, the hook carriage 103 further draws the stretcher 1 forward (see FIG. 27). When the entire stretcher 1 is laid on the vibration isolation platform 100, the driving gear 115 is stopped to complete the carrying-in operation (see FIG. 28).

As seen from the above, in putting the stretcher 1 on the vibration isolation platform 100 in this embodiment, the locking mechanism for the legs 22 is released. Since, however, the pneumatic cylinders 8 and 9 apply to the legs 22 forces toward deployment, the bed 21 is given an ascending force. Therefore, the ambulance officers 91 can hold the bed 21 in a raised position with relatively small strength or no strength. Hence, the physical burdens of the ambulance officers can be reduced. Further, the ambulance officers 91 are not given a shock so that their bodies are less likely to be strained.

Further, even after the front legs 24 are folded up, the pneumatic cylinders 9 hold the rear legs 25 in a deployed position until the limit switch 75 is turned ON. Therefore, even when the front legs 24 are folded up, the ambulance officers 91 do not receive large physical burdens.

When the length of part of the stretcher 1 laid on the platform reaches the predetermined value, the limit switch 75 is turned ON so that high-pressure gas in the pneumatic cylinders 9 is released to the atmosphere. Thus, the rear legs 25 become foldable. Therefore, the carrying-in operation of the stretcher 1 can be smoothly carried out. When high-pressure gas in the pneumatic cylinders 9 has been released to the atmosphere, the force to raise the bed 21 is eliminated so that a certain amount of physical burden may be applied to the ambulance officer 91. However, when the length of part of the stretcher 1 laid on the platform reaches the predetermined value, the front side of the stretcher 1 is supported on the vibration isolation platform 100 so that the vibration isolation platform 100 can bear most weight of the stretcher 1. Therefore, the physical burden of the ambulance officer 91 can be reduced.

Furthermore, since in this embodiment the vibration isolation platform 100 is provided with a hook carriage 103 for drawing the stretcher 1, the stretcher 1 can be pulled onto the vibration isolation platform 100 without the need for the ambulance officer 91 to push the stretcher 1. Therefore, the physical burden of the ambulance officer 91 can be reduced. In addition, even when the road is slippery, for example, due to icy conditions, the stretcher 1 can be carried in the ambulance vehicle with expedition and safety.

As described so far, according to this embodiment, the ambulance officers 91 can carry the stretcher 1 in the ambulance vehicle with ease, expedition and safety.

The conveyer for carrying the stretcher 1 onto the vibration isolation platform 100 is not limited to the conveyer for drawing the stretcher 1 using the hook carriage 103 but other types of conveyers are also applicable.

The support platform for supporting the stretcher 1 is not limited to the vibration isolation platform 100. The support platform is not limited to one installed on the ambulance vehicle but may be installed at other sites such as hospitals. Examples of the support platform include the floors of ambulance vehicles.

The conveyer 140 is not always mounted on the vibration isolation platform 100 but may be mounted on the ambulance vehicle itself.

### INDUSTRIAL APPLICABILITY

As described so far, this invention is useful especially for a stretcher used for carrying a sick or injured person in an ambulance vehicle, for example, at an ambulance work site.

1. A stretcher including a bed on which a sick or injured person will be laid, legs foldably provided on the bed and casters provided at the legs, respectively, the stretcher further comprising an ascent assist device having: a lifting mechanism for giving the bed an ascending force; and a switch for turning the lifting mechanism ON/OFF.

2. The stretcher of claim 1, wherein
the legs are configured to raise the bed by deploying from the bed, and
the lifting mechanism is configured to give the bed an ascending force by giving the legs a force toward deployment.

3. The stretcher of claim 1, wherein
the lifting mechanism has an actuator into which high-pressure gas is introduced to give the bed an ascending force, and
the stretcher further comprises a tank for storing high-pressure gas and a gas pipe line for connecting the tank and the actuator.

4. The stretcher of claim 3, wherein
the actuator is a pneumatic cylinder, and
the switch is a switch for opening and closing the flow path of the gas pipe line.

5. The stretcher of claim 4, wherein
the pneumatic cylinder has a cylinder body and a piston which divides the inner space of the cylinder body into a pressure chamber and a vented chamber, and
the stretcher further comprises a speed controller for controlling the speed of gas exhausted from the vented chamber.

6. The stretcher of claim 4, wherein the gas pipe line is provided with a speed controller for controlling the speed of high-pressure gas flowing from the tank into the pneumatic cylinder.

7. The stretcher of claim 3, wherein a gas inlet is formed through which high-pressure gas is introduced into the tank from a gas source placed in an ambulance vehicle.

8. The stretcher of claim 1, wherein the ascent assist device further comprises a speed control means for controlling the speed of the bed raised by the lifting mechanism.

9. The stretcher of claim 1, further comprising a speed control means for controlling the descending speed of the bed when the raised bed is lowered.

10. The stretcher of claim 1, further comprising a deactivation means for deactivating the ascent assist device.

11. A method for using the stretcher of claim 7, wherein before a sick or injured person is carried on the stretcher, the gas inlet is connected to the gas source in an ambulance vehicle and the tank is charged with high-pressure gas from the gas source.

12. A stretcher including a bed on which a sick or injured person will be laid, legs foldably provided on the bed to deploy with ascent of the bed and fold with descent of the bed, and casters provided at the legs, respectively, the stretcher further comprising an initial ascent assist device for giving the bed an ascending force in an initial stage of a lifting work during which the bed is raised from the lowest level to a predetermined halfway level between the lowest and highest levels of the bed.

13. The stretcher of claim 12, wherein the initial ascent assist device comprises: an actuator into which high-pressure gas is introduced to give the bed an ascending force; and a switch for turning the actuator ON/OFF.

14. The stretcher of claim 13, wherein the actuator is a pneumatic cylinder.

15. The stretcher of claim 12, wherein the initial ascent assist device comprises: a hydraulic actuator for giving the bed an ascending force; and a switch for turning the actuator ON/OFF.

16. The stretcher of claim 12, wherein the initial ascent assist device comprises: a motor-driven actuator for giving the bed an ascending force; and a switch for turning the actuator ON/OFF.

17. The stretcher of claim 12, wherein the initial ascent assist device comprises: a treadle lever pivotally mounted on the bed to angularly move through the depression by foot; and a link mechanism for converting a force of angular movement of the treadle lever to a force to raise the bed.

18. The stretcher of claim 12, further comprising a main ascent assist device for giving the bed an ascending force in a later stage of the lifting work during which the bed is raised from the halfway level to the highest level or over all the stages of the lifting work during which the bed is raised from the lowest level to the highest level.

19. The stretcher of claim 18, wherein the main ascent assist device is a device for giving the bed an ascending force by giving the legs forces toward deployment.

20. The stretcher of claim 18, the main ascent assist device comprises: a main actuator into which high-pressure gas is introduced to give the bed an ascending force; and a switch for turning the main actuator ON/OFF.

21. A stretcher which includes a bed on which a sick or injured person will be laid, legs foldably provided on the bed to deploy with ascent of the bed and fold with descent of the bed, and casters provided at the legs, respectively, and is configured to be laid on a support platform with the legs folded up by pushing the legs against the support platform as the legs deploy, the stretcher further comprising:
a deployment force application mechanism for giving the legs forces toward deployment; and
a deactivation mechanism for deactivating the deployment force application mechanism when the length of part of the stretcher laid on the support platform exceeds a predetermined length.

22. The stretcher of claim 21, wherein
the deployment force application mechanism comprises a pneumatic cylinder, and
the deactivation mechanism comprises a gas release mechanism for releasing high-pressure gas in the pneumatic cylinder.

23. A stretcher which includes a bed on which a sick or injured person will be laid, front and rear legs foldably provided at the front and rear sides of the bed, and casters provided at the front and rear legs, respectively, and is configured to be laid on a support platform from the front side of the bed with the front and rear legs folded up by pushing the legs against the support platform as the front and rear legs deploy, the stretcher further comprising:
a deployment force application mechanism for giving at least the rear legs forces toward deployment; and
a deactivation mechanism for releasing the forces toward deployment given to the rear legs from the deployment force application mechanism when the length of part of the stretcher laid on the support platform exceeds a predetermined length.

24. The stretcher of claim 23, wherein
the bed includes a rail extending in a longitudinal direction of the bed,
at least the front legs are provided with a slider for sliding on the rail according to the deployment and folding of said at least front legs, and
the deactivation mechanism comprises a position sensor for detecting whether the slider passes through a predetermined position on the rail and is configured to deactivate the deployment force application mechanism when the slider passes through the predetermined position.

25. The stretcher of claim 24, further comprising a locking mechanism for locking the front and rear legs in deploying positions such that the locking can be released in laying the stretcher onto the support platform, wherein
the deployment force application mechanism comprises a pneumatic cylinder, and
the deactivation mechanism comprises a gas release mechanism for releasing high-pressure gas in the pneumatic cylinder when the slider passes through the predetermined position.

26. A stretcher system comprising:
the stretcher of claim 21;
a support platform on which the stretcher is laid,
wherein the support platform is provided with a conveyer for conveying the stretcher onto the support platform.

27. A stretcher system comprising:
the stretcher of claim 23;
a support platform on which the stretcher is laid,
wherein the support platform is provided with a conveyer for conveying the stretcher onto the support platform.
